(19) United States
(12) Patent Application Publication
(10) Pub. No.: US 2005/0094160 A1
(43) Pub. Date: May 5, 2005

(54) Two-dimensional spectroscopic system and film thickness measuring system

(75) Inventors: Hideyuki Murai, Nara-shi (JP); Koichi Ekawa, Kyoto-fu (JP)

Correspondence Address: FOLEY AND LARDNER;SUITE 500, 3000 K STREET NW, WASHINGTON, DC, 20007, US

(73) Assignee: Omron Corporation

(21) Appl. No.: 10/938,876

(22) Filed: Sep. 13, 2004

(30) Foreign Application Priority Data
Sep. 12, 2003 (JP) 2003-321267

(51) Int. Cl. G01N 21/00; G01B 11/28

(52) U.S. Cl. 356/630; 356/419

(57) ABSTRACT

Light horizontally output from a light source 50 passes through a projection lens 51 and reaches a half mirror 52. The light reflected by the half mirror 52 coaxially reaches the measurement object 43 through a objective lens 53. The light reflected by the objective lens 53 provides an image at a image-taking unit 56 through a telecentric optical system on an object side comprising the objective lens 53 and an aperture stop 54. The light to be input to the image-taking unit 56 passes through a spectral filter provided in a multi-spectral filter 55. Here, the light source 50 and the aperture stop 54 are in an image-forming relation and the object 43 and the image-taking unit 56 are in the image-forming relation. In addition, a numerical aperture on an image side in a light-projecting optical system is greater than a numerical aperture on an object side in a light-receiving optical system, and the light source 50 outputs light which has a certain degree of divergence and forms an image having uniform light intensity at the aperture stop 54.

### BACKGROUND OF THE INVENTION

1. Field of the Invention

The present invention relates to a two-dimensional spectroscopic system for providing a spectral image of a measurement object. In addition, the present invention relates to a film thickness measuring system for measuring a film thickness of a thin film using a spectral reflection coefficient corresponding to a light wavelength. More particularly, it relates to a two-dimensional spectroscopic system and a two-dimensional film thickness measuring system suitable for inline measurement.

2. Description of the Related Art

(Need for Inline Measurement)

Recently, as a semiconductor substrate becomes large and a design rule becomes fine, a defect is liable to be generated in a manufacturing process of the semiconductor. Therefore, an enormous damage could be caused by the defect generated in the manufacturing process, so that it is increasingly needed that the manufacturing process is managed by checking a subtle malfunction so as not to generate the defect.

In addition, in a manufacturing process of a flat panel display (FPD) as represented by a liquid crystal display (LCD) or a plasma display panel (PDP), as a glass substrate becomes large, a screen becomes large, fineness is enhanced and quality becomes high. As a result, its checking becomes increasingly important in order to produce a high-quality product at a high yield ratio.

Among of all, since a film thickness of a thin film such as a resist or an oxide film formed on a surface of the semiconductor substrate or a dielectric multilayer film filter formed on a surface of a glass substrate is especially liable to be varied because of viscosity or moisture of an applied material or a surrounding temperature, it is necessary to precisely check the film thickness of the thin film so that a defect in film thickness will not be generated.

When the film thickness of the thin film is checked in the manufacturing process, conventionally, a large and expensive film-thickness checking device has been used and the film thickness is checked off-line. That is, a product is taken out from a manufacturing line or a manufacturing device and carried to the film-thickness checking device which is provided apart from the manufacturing line or the like and the film thickness of the product is measured or it is confirmed whether an intended film thickness (film thickness within management criteria) is provided there. However, in this off-line operation, when the result of the measured film thickness is not the intended film thickness, it takes time to feedback that information to the manufacturing line and the like to reflect the information in the film-forming process and modify the film thickness of the thin film. In addition, regarding the product which has not been taken out to be checked, it is determined whether its film thickness is within the management criteria or not. Consequently, the yield cannot be sufficiently improved.

Therefore, there is a demand for improving the product yield by setting a film thickness measuring system in the manufacturing line and the like and performing inline measurement in which all of the glass substrates or the semiconductor substrates are checked instead of at random check during or just after the film-forming process.

However, when a measurement object sent along the manufacturing line is measured inline as it is, a distance to the measurement object is liable to be varied and an inclination of the measurement object is also liable to be varied depending on vibration or precision of the manufacturing line. Here, the variation in distance of the measurement object device that a measurement object 26 is displaced in parallel to an optical axis direction of measuring light 27 applied from the film thickness measuring system to the measurement object 26 as shown in FIGS. 1A, 1B and 1C. In addition, the variation in inclination of the measurement object device that the measurement object 26 is inclined from a plane perpendicular to the optical axis direction of the measuring light 27 applied from the film thickness measuring system to the measurement object 26 as shown in FIGS. 2A, 2B and 2C.

Therefore, as the film thickness measuring system which can be used in inline measurement, it is required that it has the same function as the conventional film thickness measuring system for off-line measurement, miniaturization and high-speed arithmetic processing are implemented because it is set in the manufacturing line and the like, and precise measurement is also implemented under the condition of distance or inclination variation of the measurement object.

Next, a description is made of typical conventional film thickness measuring systems.

### CONVENTIONAL EXAMPLE 1

FIG. 3 shows a schematic view showing a conventional example of a film thickness measuring system (refer to Patent Application No. 2001-506442). The film thickness measuring system 1 measures a film thickness of a measurement object at a predetermined point. According to this film thickness measuring system 1, measuring light output from a light source device 2 is lead to a projector/receptor (objective lens) 4 by an optical fiber 3 and perpendicularly applied from the projector/receptor 4 toward a thin film 6 formed on a surface of a substrate 5, which is a measurement object. The measuring light reflected by both front and back surfaces of the thin film 6 is input to the projector/receptor 4 and sent from the projector/receptor 4 to an optical filter 8 through the optical fiber 7. When the measuring light reflected by the thin film 6 is sent to the optical filter 8, the measuring light is split by the optical filter 8 and the split measuring light is received by a receptor 9 such as a CCD and the like. An output signal of the receptor 9 is sent to a arithmetic processing unit 10 and a film thickness of the thin film 6 is calculated by the arithmetic processing unit 10.

However, when the two-dimensional film thickness measurement is performed by the film thickness measuring system 1, it is necessary to scan a stage on which the substrate 5 is set or relatively adjust a distance between the system and the measurement object by moving the system itself. Therefore, it takes time, and since a mechanism for moving the stage or a light-receiving optical system is needed, the film thickness measuring system becomes large. Consequently, it is difficult to incorporate the system in the manufacturing line or in the manufacturing system and perform the inline measurement.

### CONVENTIONAL EXAMPLE 2

FIG. 4 shows a schematic view showing another conventional example of the film thickness measuring system (refer to Patent Application No. 8-262828). A light-projecting optical system of a film thickness measuring system 11 comprises a light source 12 emitting light for measurement, a first convex lens 13, an aperture stop 14, a field stop 15, a second convex lens 16, a half mirror 17, a third stop 18, and an objective lens 19. The light emitted from the light source 5 passes through the light-projecting optical system and it is projected onto a predetermined two-dimensional region of a measurement object 20.

A light-receiving optical system of the film thickness measuring system 11 comprises the objective lens 19, the third stop 18, a stop 22, a third convex lens 21 by which the light which was reflected by the measurement object 20 and passed through the objective lens 19 and the half mirror 17, forms an image on the stop 22, a transmission wavelength variable filter 23, a CCD camera 24 for taking a spectral image, and a spectral reflection coefficient measuring device 25 for measuring a spectral reflection coefficient based on the spectral image. The stop 22 passes the reflected light from a predetermined region of the measurement object 20 only and cuts the light reflected by unnecessary parts. In addition, the transmission wavelength variable filter 23 as a device for splitting the light and an optical system (not shown) in which the image on the stop 22 is formed on an image-taking surface of the CCD camera 24 are provided between the stop 22 and the image-taking surface of the CCD camera 24. Thus, the system is constituted such that a wavelength of the reflection light reaching the spectral reflection coefficient measuring device 25 from the two-dimensional region of the measurement object 20 can be selected and the selected wavelength can be changed.

According to the film thickness measuring system 11 as thus constituted, spectral images having a plurality of wavelengths can be provided and the spectral reflection coefficients in a predetermined two-dimensional region of the measurement object 20 can be measured at the two-dimensional region in a lump by only switching the transmission wavelength variable filter 23. Therefore, according to the film thickness measuring system 11, miniaturization of the system and high-speed arithmetic processing are implemented.

However, according to a measurement object 20 such as a semiconductor or FPD in the manufacturing process, since the measurement object 20 has mirror reflection surface in many cases, when the measurement object 20 is inclined, as show in FIG. 5, the reflection light from the measurement object 20 is prevented by the third stop 18, so that light intensity of the observed image is varied and the film thickness cannot be precisely measured.

If the third stop 18 is omitted in the film thickness measuring system 11, although characteristics on the occasion of the inclination variation of the measurement object 20 is improved, in this case, when the measurement object 20 is moved, there is no image-forming relation between the CCD camera 24 and the measurement object 20, so that the image becomes blurred and the film thickness cannot be precisely measured.

Thus, according to the conventional film thickness measuring system 11, since the film thickness cannot be precisely measured when the measuring condition of the measurement object 20 is varied or the measurement object 20 is measured in bad conditions, this film thickness measuring system 11 cannot be used for the inline measurement.

### SUMMARY OF THE INVENTION

The present invention was made in view of the above technical problems and it is an object of the present invention to provide a two-dimensional spectroscopic system which is suitable for measuring an spectral image of a measurement object inline. In addition, it is another object of the present invention to provide a film thickness measuring system which is suitable for inline measuring a film thickness of a thin film in a two-dimensional region of a measurement object.

A two-dimensional spectroscopic system according to the present invention comprises a light-projecting optical system in which a measurement object is irradiated with light from a light source, an image-taking device for taking a monochromatic image of the measurement object, and a light-receiving optical system in which an image of the measurement object is provided at the image-taking device, in which the light-receiving optical system is constituted by a telecentric light-receiving optical system comprising an image-forming device and an aperture stop. According to the two-dimensional spectroscopic system, it is preferable that the image-forming device exists on the measurement object side of the aperture stop.

According to one aspect of the two-dimensional spectroscopic system of the present invention, an optical axis of the light-projecting optical system and an optical axis of the light-receiving optical system are coaxially provided only on the side of the measurement object of the aperture stop in the light-receiving optical system.

According to another aspect of the two-dimensional spectroscopic system of the present invention, spot light generated at a position of the aperture stop by the light output by the light source and reflected by the measurement object is larger than a size of a small aperture of the aperture stop. When the measurement object reflects incident light by specular reflection, it can be expressed such that a numerical aperture on an image side in the light-projecting optical system is greater than a numerical aperture on an object side in the light-receiving optical system.

In this case, it is preferable that the light source outputs light which provides an image on the measurement object through the light-projecting optical system and provides a uniform distribution of an outgoing light amount on a plane which is in an image-forming relation with a surface of the measurement object.

Alternatively, it is preferable that the light source outputs light which provides an image on the aperture stop through the light-projecting optical system, the measurement object and the light-projecting optical system, and provides a uniform distribution of an outgoing light amount on a plane which is in an image-forming relation with the aperture stop.

According to still another aspect of the two-dimensional spectroscopic system of the present invention, it is preferable that an optical axis of the light-projecting optical system and an optical axis of the light-receiving optical system are coaxially provided only between the image-forming device and the measurement object.

According to still another aspect of the two-dimensional spectroscopic system of the present invention, it is preferable that an aperture diameter of the aperture stop is set so that the numerical aperture on the object side in the light-receiving optical system becomes 0.02 or less.

According to still another aspect of the two-dimensional spectroscopic system of the present invention, a splitting device for splitting the light reflected by the measurement object may be provided in the light-receiving optical system.

In addition, according to still another aspect of the two-dimensional spectroscopic system of the present invention, a splitting device for projecting a split light onto the measurement object may be provided in the light-projecting optical system.

In this case, it is more preferable that the light-projecting optical system is arranged such that an optical axis direction of the light-projecting optical system is almost parallel to a normal line direction of the measurement object.

A film thickness measuring system according to the present invention comprises the above two-dimensional spectroscopic system and an arithmetic processing device for calculating a film thickness of a measurement object based on a monochromatic image provided by the two-dimensional spectroscopic system.

In addition, the components of the present invention described above may be combined arbitrarily as much as possible.

According to the two-dimensional spectroscopic system of the present invention, since the light-receiving optical system is constituted by a telecentric light-receiving optical system comprising the image-forming device and the aperture stop, even when the measurement object is varied in distance, a stable spectral image can be provided. Especially, since the image-forming device is arranged on the side of the measurement object of the aperture stop, which becomes the telecentric optical system on the object side or the telecentric optical system on both sides, the spectral image can be stably provided even when the measurement object is varied in distance.

In addition, according to the two-dimensional spectroscopic system of the present invention, when the optical axis of the light-projecting and the optical axis of the light-receiving optical system become coaxial only on the side of the measurement object of the aperture stop in the light-receiving optical system, since the light applied to the measurement object is not limited by the aperture stop before it is applied to the measurement object, the numerical aperture on the image side in the light-projecting optical system, that is, the divergence of the light applied to the measurement object can be prevented from becoming small and the spectral image can be stably provided even when the inclination of the measurement object is varied.

According to the two-dimensional spectroscopic system of the present invention, when spot light generated at a position of the aperture stop by the light output from the light source and reflected by the measurement object is larger than a size of a small aperture of the aperture stop (or in a case the measurement object reflects incident light by specular reflection, when a numerical aperture on an image side in the light-projecting optical system is greater than a numerical aperture on an object side in the light-receiving optical system), the spectral image can be stably provided even when the inclination of the measurement object is varied.

In this case, when the light source outputs light which provides an image on the measurement object through the light-projecting optical system and provides a uniform distribution of an outgoing light amount on a plane which is in an image-forming relation with a surface of the measurement object, the light amount of the image taken by the image-taking device is not likely to be changed even when the measurement object is inclined.

Alternatively, when the light source outputs light which provides an image on the aperture stop through the light-projecting optical system, the measurement object and the light-receiving optical system, and provides a uniform distribution of an outgoing light amount on a plane which is in an image-forming relation with the aperture stop, the light amount of the image taken by the image-taking device is not likely to be changed even when the measurement object is inclined.

According to the two-dimensional spectroscopic system of the present invention, when an optical axis of the light-projecting optical system and an optical axis of the light-receiving optical system are coaxially provided only between the image-forming device and the measurement object, since the light source is positioned between the image-forming device and the measurement object, the light applied from the light-projecting optical system to the measurement object is not reflected by the image-forming device and the light amount of the image taken by the image-taking device is prevented from being lowered.

According to the two-dimensional spectroscopic system of the present invention, when an aperture diameter of the aperture stop is set so that the numerical aperture on the object side in the light-receiving optical system becomes 0.02 or less, the system can be optimally designed such that a spectral image can be stably provided even when the distance of the measurement object is varied.

According to the two-dimensional spectroscopic system of the present invention, a splitting device for splitting the light reflected by the measurement object may be provided in the light-receiving optical system or in the light-projecting optical system. In the latter case, an optical resolution can be improved by arranging the light-projecting optical system such that an optical axis direction of the light-projecting optical system is almost parallel to a normal line direction of the measurement object.

According to the film thickness measuring system of the present invention, by using the above two-dimensional spectroscopic system, there can be provided a film thickness measuring system in which inline measurement and two-dimensional measurement can be implemented even when the measurement object is varied in distance or inclination.

### BRIEF DESCRIPTION OF THE DRAWINGS

FIGS. 1A, 1B and 1C show views for explaining the meaning of variation in distance of a measurement object.

FIGS. 2A, 2B and 2C show views for explaining the meaning of variation in inclination of the measurement object.

FIG. 3 shows a schematic view showing a constitution of a conventional film thickness measuring system.

FIG. 4 shows a schematic view showing a constitution of another conventional film thickness measuring system.

FIG. 5 shows a partially enlarged view showing behavior of rays of light when the measurement object is inclined in the film thickness measuring system.

FIG. 6 shows an entire constitutional view showing a film thickness measuring system according to an embodiment 1 of the present invention.

FIG. 7 shows a block diagram showing an electrical constitution of the film thickness measuring system of the embodiment 1.

FIG. 8 shows a schematic view showing an optical constitution of a sensor head used in the film thickness measuring system of the embodiment 1.

FIG. 9 shows a plan view showing an enlarged multi-spectral filter.

FIG. 10A to 10F show views showing images of a TFT array substrate observed through spectral filters having different selection wavelengths.

FIG. 11 shows a view showing theoretical spectral reflection coefficients of SiO₂ thin films having film thickness of 500 nm and 1000 nm.

FIG. 12 show a flowchart showing a processing flow when a film thickness is measured by the film thickness measuring system.

FIG. 13A shows a view showing a telecentric optical system on an image side, 13B shows a view showing a telecentric optical system on an object side, and 13C shows a view showing a telecentric optical system on both sides.

FIG. 14A shows a view showing behavior of rays of light, an object appearance and an image appearance of the object shifted from an imaging position in a general imaging optical system, 14B is a view showing behavior of rays of light and an image appearance of the object shifted from the imaging position in an imaging optical system using the telecentric optical system on the object side.

FIG. 15 shows a view showing the optical system in the film thickness measuring system shown in FIG. 8 and behavior of its rays of light.

FIG. 16A shows a view showing behavior of rays of light when a relatively large aperture stop is used and 16B is a view showing behavior of rays of light when a small aperture stop is used.

FIG. 17A shows a plan view showing a ronchi ruling, 17B is a view showing ideal distribution of light intensity when the ronchi ruling is observed at a image-taking unit.

FIG. 18 shows a schematic view showing a telecentric optical system on the object side of 3 magnifications using a aperture stop in which a numerical aperture NA is 0.055 (a diameter of the aperture stop is 3 mm).

FIGS. 19A and 19B show views each showing an image and waveforms of light intensity distribution when the ronchi ruling shown in FIG. 17A is observed using the above telecentric optical system.

FIG. 20 shows a schematic view showing a telecentric optical system on the object side of 3 magnifications using an aperture stop in which a numerical aperture NA is 0.01 (a diameter of the aperture stop is 0.5 mm).

FIGS. 21A and 21B show views each showing an image and waveforms of light intensity distribution when the ronchi ruling shown in FIG. 17A is observed using the above telecentric optical system.

FIG. 22A shows a view showing behavior of rays of light when the inclination of the measurement object is 0° in a simple telecentric optical system, 22B is a view showing behavior of rays of light when the inclination of the measurement object is 1° in a simple telecentric optical system, and 22C is a view showing behavior of rays of light when the inclination of the measurement object is −1° in a simple telecentric optical system.

FIG. 23A shows a view for explaining a light-source reference face in a light source and 23B is a view showing definition of a numerical aperture taken from the image side and a numerical aperture of measuring light reflected by the measurement object.

FIGS. 24A and 24B show views for explaining behavior of light in the film thickness measuring system according to the embodiment 1 using the telecentric optical system on the object side as the imaging optical system, in which an image of the light source is provided at the aperture stop, and the image of the measurement object is provided at the image-taking unit;

FIG. 25A is a view showing behavior of rays of light when the inclination of the measurement object is 0° in the film thickness measuring system of the embodiment 1, FIG. 25B is a view showing behavior of rays of light when the inclination of the measurement object is 1° in the film thickness measuring system of the embodiment 1, and FIG. 25C shows a view showing behavior of rays of light when the inclination of the measurement object is −1° in the film thickness measuring system of the embodiment 1.

FIG. 26 shows a schematic side view showing an example of the light source used in the film thickness measuring system of the present invention.

FIG. 27 shows a schematic side view showing another example of the light source used in the film thickness measuring system of the present invention.

FIG. 28 shows a view for explaining behavior of light according to a variation of the embodiment 1.

FIG. 29 shows a schematic view showing an optical constitution of a sensor head of a film thickness measuring system according to an embodiment 2 of the present invention.

FIG. 30A shows a schematic view showing reflection of light at an objective lens in the film thickness measuring system of the embodiment 2 and 30B shows a schematic view showing reflection of light at an objective lens in the film thickness measuring system of the embodiment 1.

FIG. 31 shows a view showing an image of drafting paper observed by the film thickness measuring system in which there is light reflection at the objective lens as shown in FIG. 30B.

FIG. 32 shows a view showing an image of a TFT array substrate observed by the film thickness measuring system in which there is light reflection at the objective lens as shown in FIG. 30B.

FIG. 33A shows a view showing behavior of light when the light from the light source is reflected toward the measurement object by a cube type of beam splitter and 33B a view showing behavior of light when the light from the light source is reflected toward the measurement object by a half mirror.

FIG. 34 shows a view showing behavior of light in the vicinity of the measurement object showing optimal value of the numerical aperture in the embodiment 2 of the present invention.

FIG. 35A shows a view showing an image when a ronchi ruling having line width of 41 μm positioned at an imaging position (distance variation is 0 mm) is observed, and 35B shows a view showing an image when the ronchi ruling having line width of 41 μm is observed at a position shifted from the imaging position by 0.5 mm.

FIG. 36 shows a view showing waveforms of light intensity distribution in which the ronchi ruling having a line width of 41 μm is observed when the distance variation is ±0.5 mm and 0 mm.

FIG. 37 shows a schematic view showing a constitution of an optical system of a film thickness measuring system according to an embodiment 3 of the present invention.

FIGS. 38A and 38B show a plan view and a side view showing a measurement object observed using the film thickness measuring system of the embodiment 3, respectively.

FIGS. 39A and 39B show views each showing a result (solid-line waveform) in which spectral reflection coefficients of an SiO₂ film at the imaging position are observed at a point Q1 or Q2 shown in FIG. 38A and theoretical spectral reflection coefficients (broken-line waveform).

FIGS. 40A and 40B show views each showing a result (solid-line waveform) in which spectral reflection coefficients of the SiO₂ film at the imaging position are observed at a point Q3 or Q4 shown in FIG. 38A and theoretical spectral reflection coefficients (broken-line waveform).

FIGS. 41A and 41B show views each showing a result (solid-line waveform) in which spectral reflection coefficients of the SiO₂ film at the imaging position are observed at a point Q5 or Q6 shown in FIG. 38A and theoretical spectral reflection coefficients (broken-line waveform).

FIGS. 42A and 42B show views each showing a result (solid-line waveform) in which spectral reflection coefficients of the SiO₂ film at the imaging position are observed at a point Q7 or Q8 shown in FIG. 38A and theoretical spectral reflection coefficients (broken-line waveform).

FIG. 43 shows a view showing a result (solid-line waveform) in which spectral reflection coefficients of the SiO₂ film at the imaging position are observed at a point Q9 shown in FIG. 38A and theoretical spectral reflection coefficients (broken-line waveform).

FIGS. 44A and 44B show views each showing spectral reflection coefficients when the sample is shifted from the imaging position by ±0.25 mm or ±0.50 mm and spectral reflection coefficients when the sample is at the imaging position.

FIGS. 45A and 45B show views each showing spectral reflection coefficients when the sample is shifted from the imaging position by ±0.75 mm or ±1.00 mm and spectral reflection coefficients when the sample is at the imaging position.

FIGS. 46A and 46B show views each showing spectral reflection coefficients when the sample is inclined by ±0.25° or ±0.50° from the direction perpendicular to an optical axis of incident illumination light and spectral reflection coefficients when the inclination of the sample is 0°.

FIGS. 47A and 47B show views each showing spectral reflection coefficients when the sample is inclined by ±0.75° or ±1.00° from the direction perpendicular to an optical axis of incident illumination light and spectral reflection coefficients when the inclination of the sample is 0°.

FIG. 48 shows a table showing film thickness values of the SiO₂ film calculated from the results in FIG. 44A, 44B, FIGS. 45A and 45B and its film thickness differences (measurement error).

FIG. 49 shows a table showing film thickness values of the SiO₂ film calculated from the results in FIG. 46A, 46B, FIGS. 47A and 47B and its film thickness differences (measurement error).

FIG. 50 shows a schematic view showing an optical system of a film thickness measuring system according to an embodiment 4 of the present invention.

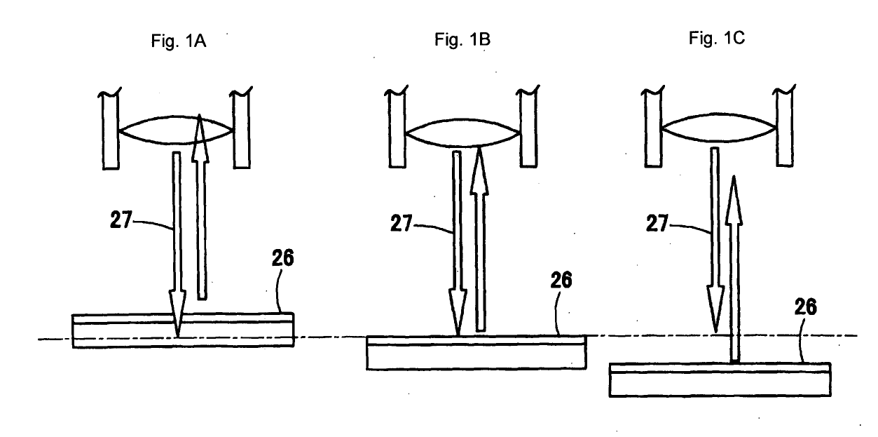

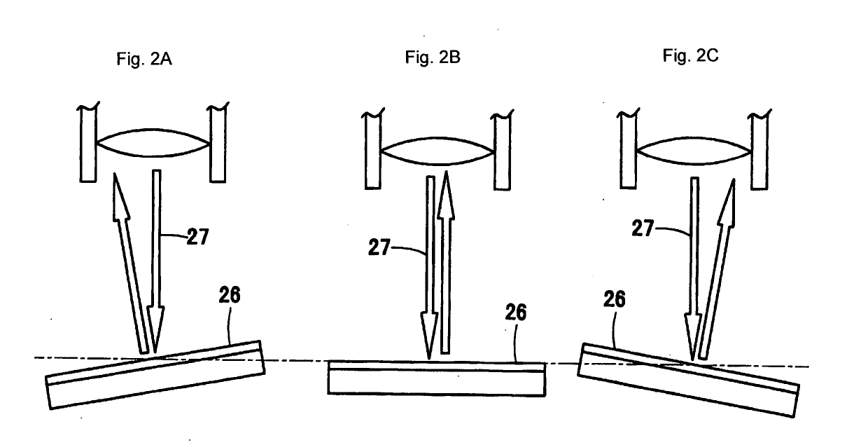

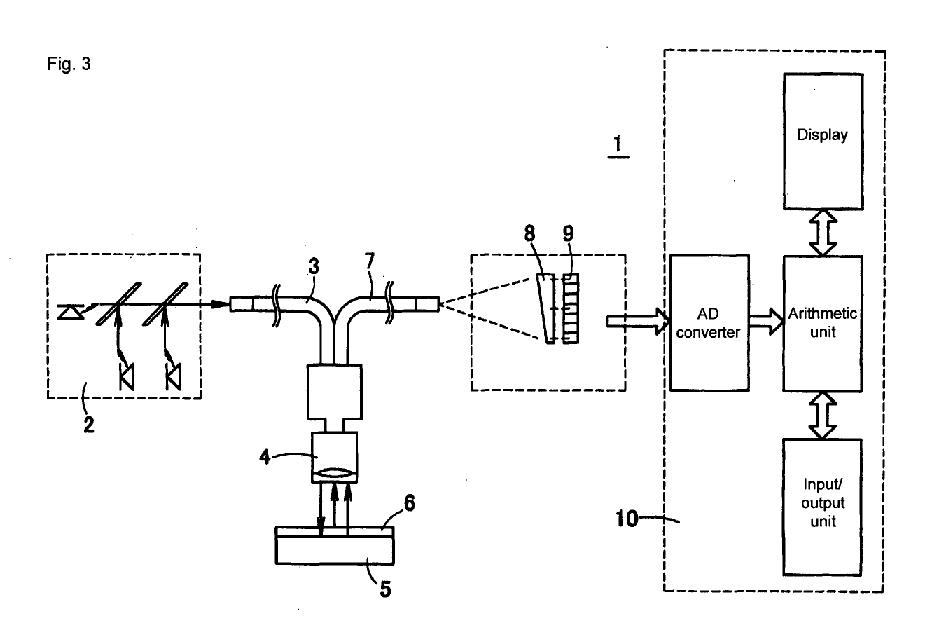

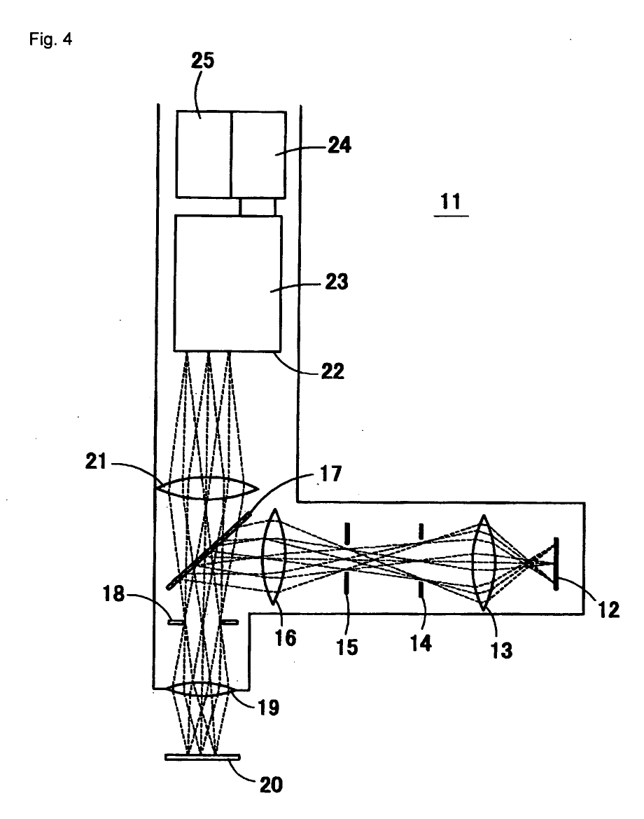

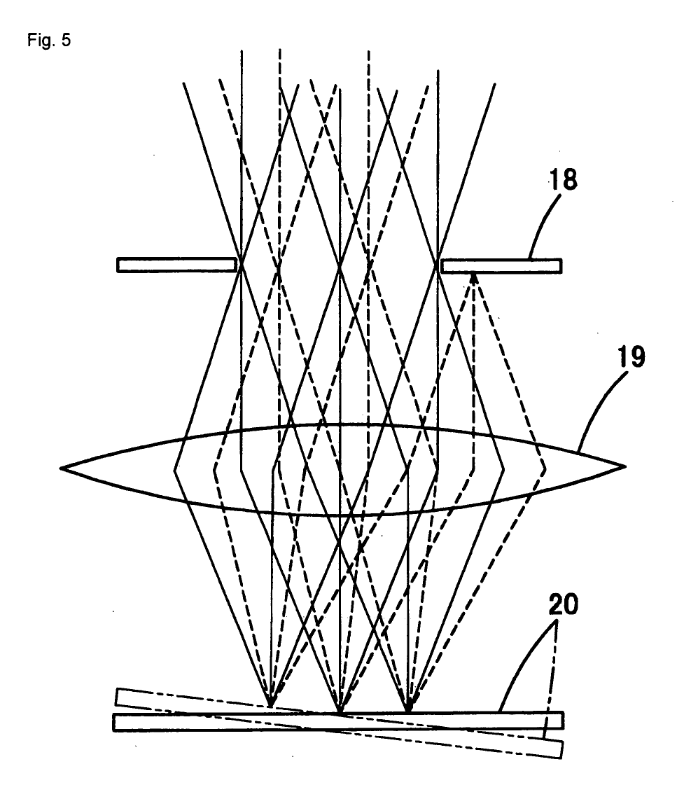

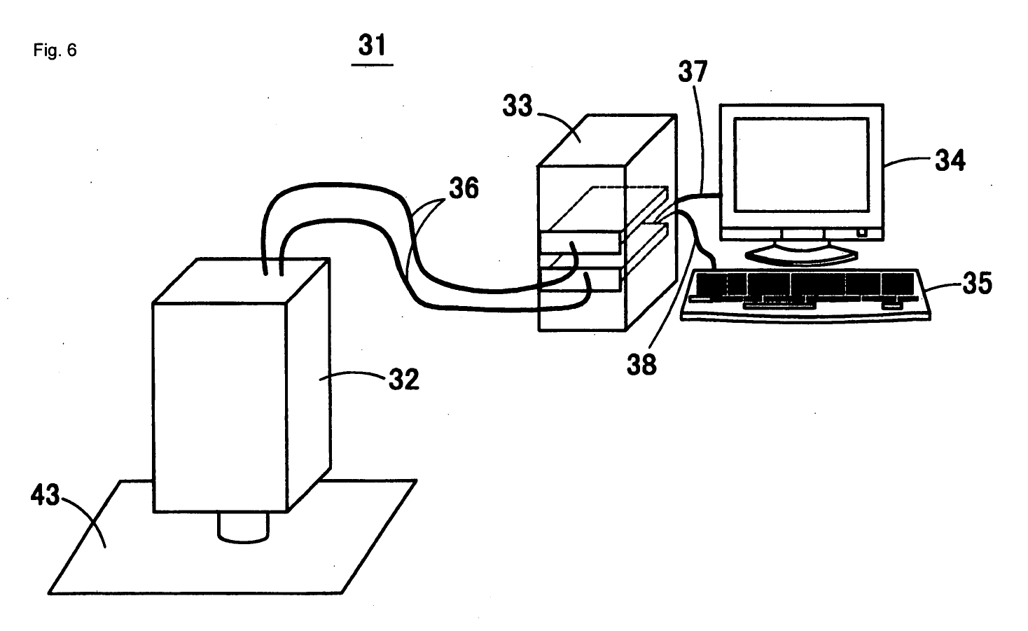

### DESCRIPTION OF THE PREFERRED EMBODIMENTS

Hereinafter, embodiments of the present invention are described in detail with reference to the drawings.

### Embodiment 1

FIG. 6 shows an overall view showing a film thickness measuring system 31 which can measure a two-dimensional film thickness according to an embodiment 1 of the present invention. The film thickness measuring system 31 comprises a sensor head 32, an arithmetic processing unit 33 and an external interface (I/F). In the illustrated example, the external interface comprises a display 34 and an input/output unit 35 such as a keyboard, a mouse and the like. In addition, the sensor head 32 and the arithmetic processing unit 33 are connected by a cable 36, and the arithmetic processing unit 33 and the display 34 are connected by a cable 37, and the arithmetic processing unit 33 and the input/output unit 35 are connected by a cable 38.

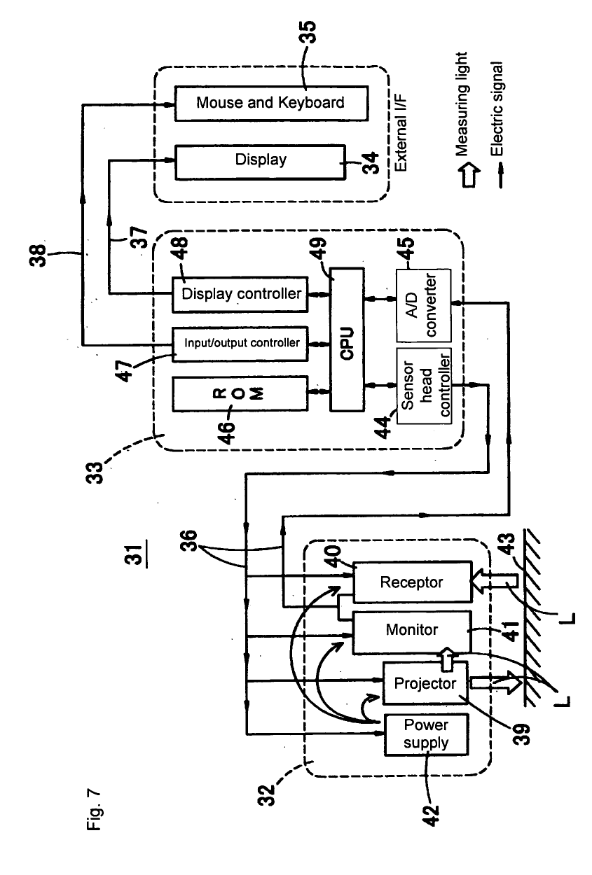

FIG. 7 shows a block diagram showing an electrical constitution of the film thickness measuring system 31. The sensor head 32 comprises a projector 39, a receptor 40, a monitor 41 and a power supply 42. The sensor head 32 performs measurement such that measuring light L emitted from the projector 39 is applied to a measurement object 43, and the measuring light L reflected by the measurement object 43 is received by the receptor 40 to be observed. The monitor 41 monitors fluctuation in light intensity of the measuring light L output from the projector 39 and directly receives a part of the measuring light L output from the projector 39. In addition, the power supply 42 applies a power to the projector 39, the receptor 40 and the monitor 41 to drive them. The power supply 42 may be provided in the sensor head 32 or may be mounted on the arithmetic processing unit 33 so as to be provided outside of the sensor head 32.

The arithmetic processing unit 33 comprises a sensor head controller 44, an A/D converter 45, a nonvolatile memory 46 such as a ROM, an input/output controller 47, a display controller 48, and a main controller 49 for calculating/controlling these, such as a micro processor (CPU). The sensor head controller 44 controls the projector 39, the receptor 40, the monitor 41 and the power supply 42. The A/D converter 45 converts an analog signal from the receptor 40 and the monitor 41 to a digital signal. The nonvolatile memory 46 stores various kinds of programs. The input/output controller 47 is connected to the input/output unit 35 such as the keyboard and the mouse through the cable 38. The display controller 48 is connected to the display 34 through the cable 37.

Thus, the sensor head controller 44 makes the projector 39 emit light at a predetermined timing to irradiate the measurement object 43 with the measuring light L. At the same time, the monitor 41 receives a part of the measuring light L emitted from the projector 39, and outputs a monitor signal corresponding to the amount of light, to the A/D converter 45 through the cable 36. The monitor signal (analog signal) is converted to the digital signal by the A/D converter 45 and sent to the main controller 49. The main controller 49 calculates the light intensity of the measuring light L output from the projector 39 based on the digitized monitor signal, and when the light intensity is not equal to the predetermined light intensity, it controls the projector 39 through the sensor head controller 44 so that the light intensity of the projector 39 may become the predetermined light intensity by feedback-controlling.

In addition, a image signal of the measurement object taken by the receptor 40 is output to the A/D converter 45 through the cable 36. The image signal which was converted to the digital signal by the A/D converter 45 is sent to the main controller 49 so that a film thickness of a thin film at a predetermined position is calculated as will be described below. The image of the measurement object 43 or a calculated result of the film thickness and the like are displayed based on the image signal output from the receptor 40 in the display 34 by the display controller 48. In addition, when data of the measurement position or a refractive index of the film thickness, for example is input from the input/output unit 35, the input/output controller 47 sends the data of the measurement position and the like to the main controller 49.

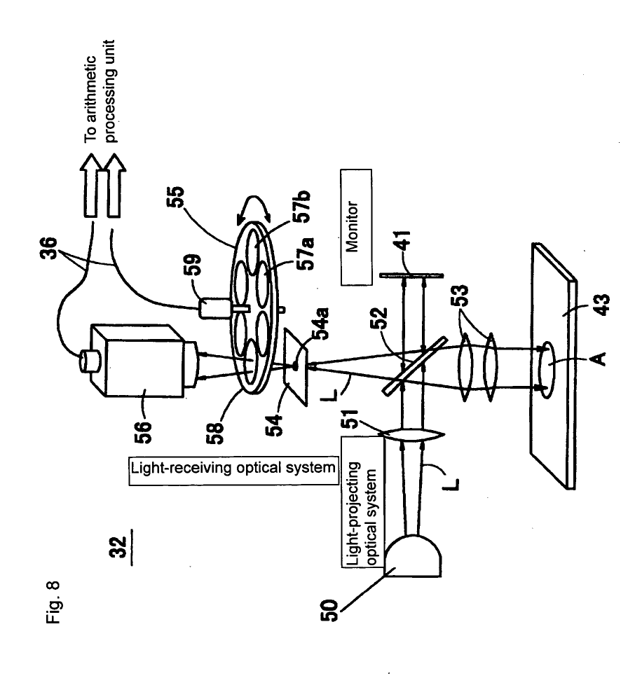

FIG. 8 shows a schematic view showing an optical constitution of the sensor head 32. The projector 39 in the sensor head 32 comprises a light source 50 and a light-projecting optical system. The light-projecting optical system comprises a projection lens 51, a half mirror 52 and an objective lens 53. The receptor 40 comprises a light-receiving optical system and an image-taking unit 56 comprising a CCD camera and the like. The light-receiving optical system comprises the objective lens 53, an aperture stop 54 and a multi-spectral filter 55. The monitor 41 comprises a light-receiving device such as a photodiode (PD). The half mirror 52 is arranged at an angle of 45 degrees with respect to an optical axis of the measuring light L projected to the measurement object 43, and the light source 50 and the projection lens 51 are arranged on one side of the half mirror 52 so as to set the optical axis in the horizontal direction. The monitor 41 is arranged so as to be opposed to the light source 50 and the projection lens 51 across the half mirror 52. Thus, the measuring light L emitted from the light source 50 passes through the projection lens 51 and then enters the half mirror 52. A part of the light input to the half mirror 52 is reflected by the half mirror 52 and passes through the objective lens 53 to reach a predetermined two-dimensional region A of the measurement object 43. A part of the rest of light passes through the half mirror 52 and reaches the monitor 41 as light for monitoring. Here, it is assumed that the measuring light L reaching the measurement object 43 is coaxial incident light which reaches the measurement object 43 in the perpendicular direction. In addition, the measurement object is a thin film formed on a surface of a substrate and the like in a semiconductor manufacturing process or a FPD manufacturing process.

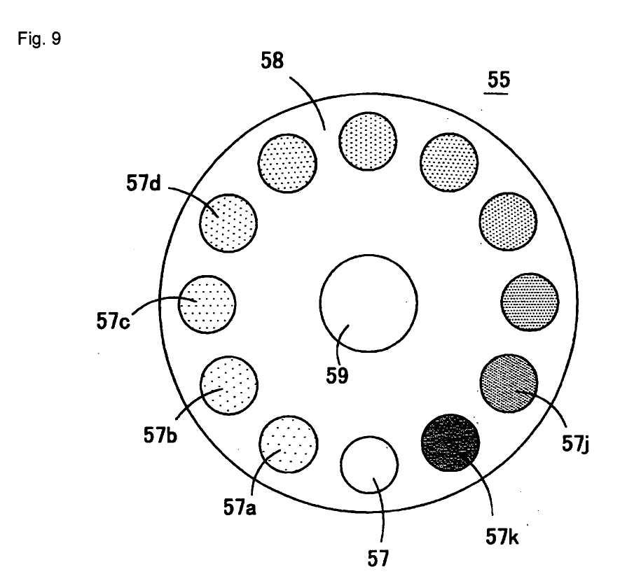

The half mirror 52 is positioned over the objective lens 53, and the aperture stop 54, the multi-spectral filter 55 and the image-taking unit 56 are positioned above the half mirror 52. As shown in FIG. 9, the multi-spectral filter 55 provided between the image-taking unit 56 and the measurement object 43 can change an angle by rotating a filter plate 58 provided with a plurality of spectral filters 57a, 57b, . . . having different transmission wavelength ranges by a rotary actuator 59 such as a pulse step motor and the like. A plurality of opening are provided concentrically at a periphery of the filter plate 58 around the center of the rotation axis of the rotary actuator 59. Transmission type of spectral filters (band-pass filter) 57a, 57b . . . having different selection wavelengths are fit in the openings except for one and the one opening is a through hole 57 in which the spectral filter is not provided. A dielectric multilayer film and the like can be used as the transmission type of spectral filters 57a, 57b . . . The filter plate 58 of the multi-spectral filter 55 is closely arranged over the aperture stop 54, and the through hole 57 or the any of the spectral filters 57a, 57b . . . can be moved to a position opposed to a small aperture 54a of the aperture stop 54 by rotating the filter plate 58 by the rotary actuator 59. Thus, when any one of spectral filters 57a, 57b . . . is positioned over the small aperture 54a, white light which passed through the small aperture 54a impinges on the spectral filter 57a, for example which is just above the small aperture 54a, whereby only light of a specific wavelength range which is decided by the spectral filter reaches the image-taking unit 56.

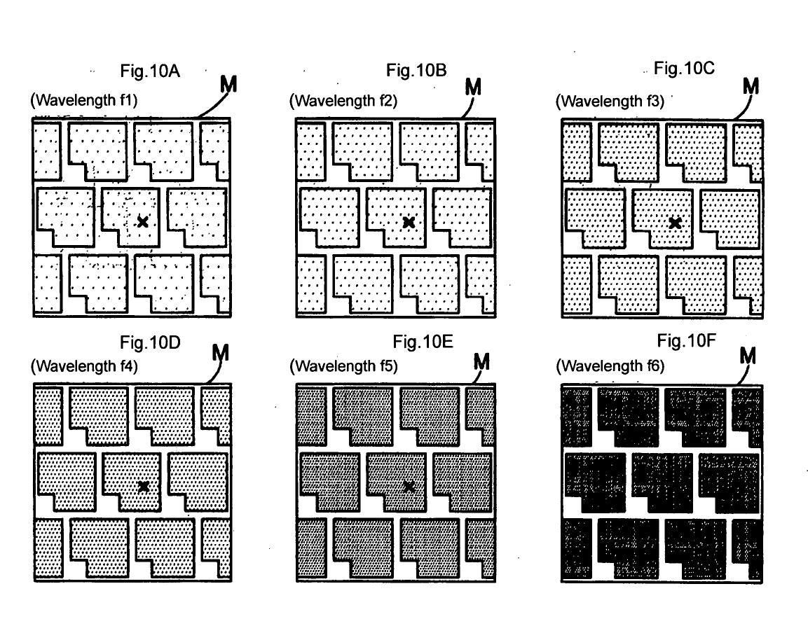

Thus, the measuring light L which reached the predetermined two-dimensional region A of the measurement object 43 and reflected by the measurement object 43 passes through the objective lens 53, the half mirror 52, the small aperture 54a, and any one of spectral filters 57a, 57b . . . and reaches the image-taking unit 56. In addition, the measurement object 43 and the image-taking unit 56 are arranged so as to form an image, and each point in the two-dimensional region A of the measurement object 43 corresponds to each pixel of the image-taking unit 56 one by one. Here, by sequentially switching the spectral filters 57a, 57b . . . by rotating the multi-spectral filter 55, as shown in FIG. 10A to 10F, spectral images like images M on a TFT array substrate of various wavelengths f1, f2 . . . which are decided by the spectral filters 57a, 57b . . . are observed by the image-taking unit 56, and each spectral image is stored in a memory (not shown) such as a hard disk and the like. Then, a certain pixel (that is, any one point in the two-dimensional region A) like a point in a pixel opening to which a mark “x” is allotted in FIG. 10A to 10F is selected, data of a spectral reflection coefficient of the selected pixel is retrieved from stored spectral image data of each wavelength, and the spectral reflection coeffcient data is compared with a theoretical spectral reflection coefficient, thereby to calculate a film thickness at the selected point by the arithmetic processing unit 33. In addition, an operation of the aperture stop 54 is described later.

The theoretical spectral reflection coefficient is designated by a formula (1) when the thin film is a single-layer film, for example. In addition, although a formula designating the theoretical spectral reflection coefficient when the thin film is the multilayer film is also known, it is omitted here.

$$\begin{matrix}Formula 1 \\ R = {\vert \frac{{r}_{0} + {r}_{1} exp ( - i \frac{4 π}{λ} nd )}{1 + {r}_{0} {r}_{1} exp ( - i \frac{4 π}{λ} nd )} \vert}^{2}\end{matrix} \qquad ( 1 )$$

Here, reference character R designates a reflection coefficient and when it is assumed that light intensity input to the thin film is Ii and light intensity reflected by the thin film is Ir, it is designated such that R=(Ir/Ii). In addition, reference character d designates a film thickness of the thin film, reference character n designates a refractive index of the thin film, reference character λ designates a wavelength of incident light in air and reference character i designates an imaginary unit. In addition, reference character r₀ and r₁ are amounts regarding a refractive index no of a substrate supporting the thin film, a refractive index n of the thin film, and a refractive index na of air, and designated by the following formulas (2) and (3).

$$\begin{matrix}\begin{matrix}Formula 2 \\ {r}_{0} = \frac{n - no}{n + no}\end{matrix} & ( 2 ) \\ \begin{matrix}Formula 3 \\ {r}_{0} = \frac{na - n}{na + n}\end{matrix} & ( 3 )\end{matrix}$$

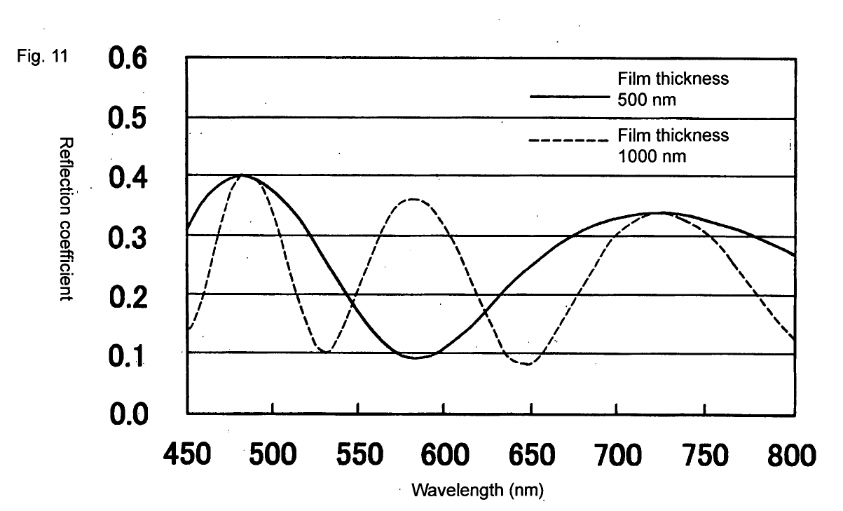

Thus, when the refractive indexes no and n of the substrate and the thin film, respectively and the wavelength λ of the incident light are known, the above formula (1) becomes a function of the film thickness d of the thin film and there can be provided a theoretical spectral reflection coefficient for any film thickness d. For example, if it is assumed that the substrate is formed of Si and the thin film is formed by SiO₂, when the film thicknesses of the thin films d are 500 nm and 1000 nm, the theoretical spectral reflection coefficients are provided as shown FIG. 11 from the above formula (1).

As can be seen from FIG. 11, as the film thickness of the thin film is varied, the waveform of the theoretical spectral reflection coefficient is also varied. Thus, when the spectral reflection coefficient is measured and this is compared with the theoretical spectral reflection coefficient, the film thickness of the thin film can be decided. In addition, if a measured values of the spectral reflection coefficients for the wavelength of the light can be found for many wavelengths, even when the refractive index of the thin film or the refractive index of the substrate is unknown other than the film thickness of the thin film, these unknown values can be found from the above formula (1).

As a film thickness calculating method by the arithmetic processing unit 33, a curve fitting method can be used. According to the curve fitting method, waveform data (table data) for each film thickness which was previously calculated and stored as a table is compared with the light-receiving data, data which has a smallest error with the light-receiving data is extracted by a least-square method and the film thickness of the waveform data is set as the film thickness of the thin film to be measured. As the film thickness calculating method, a method such as an extreme-value searching method may be used other than the curve fitting method.

In addition, according to the film thickness measuring system 31, when the pixel position in which spectral reflection coefficient data is extracted according to each image is varied to calculate the film thickness as described above, the film thickness of the thin film positioned at a certain point in the two-dimensional region A can be calculated without moving the measurement object 43 or the film thickness measuring system 31. Thus, the two-dimensional measurement can be performed.

According to the film thickness measuring system 31 as thus constituted, since the spectral images of the plurality of wavelengths can be provided only by switching the multi-spectral filter 55 and the spectral reflection coefficients in the predetermined two-dimensional region A of the measurement object 43 can be measured together, the size of the film thickness measuring system 31 can be reduced and arithmetic processing can be performed at high speed.

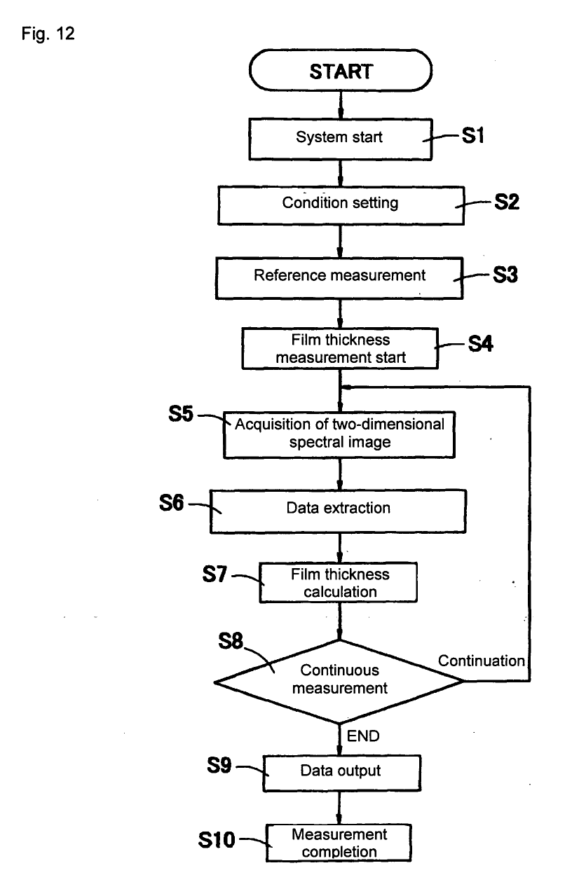

FIG. 12 shows a flowchart showing the processes when the film thickness is measured by the film thickness measuring system 31. In addition, since a method of calculating the film thickness from a measured interference waveform is the same as the method disclosed in Patent Application No. 2001-506442, for example, its description is omitted here. According to the film thickness measurement, a power supply of the film thickness measuring system 31 is turned on to start the system at step S1, and measuring conditions required for measuring a refractive index, an absorption coefficient, the number of measuring points, a measuring distance of the thin film (single-layer film and multilayer film) to be measured are input from the input/output unit 35 to set the conditions at step S2. Then, when the measurement is performed for the first time or when the kind of the measurement object is changed, reference (reference value) measurement is performed using a sample whose amount of reflection light is known at step S3 to confirm that the film thickness measuring system 31 is correctly adjusted.

When the measurement is started at step S4, a two-dimensional spectral image of each wavelengths is sequentially taken by the image-taken unit 56 while the spectral filters 57a, 57b, . . . are sequentially switched by rotating the multi-spectral filter 55, to store the two-dimensional spectral images of the wavelengths in the memory unit at step S5. Then, the spectral reflection coefficient data of the pixel at a position in which the film thickness is to be measured is extracted from the two-dimensional spectral images stored in the memory unit at step S6 and the film thickness is calculated from the spectral reflection coefficient data at step S7. In steps 5 and 6, when spectral reflection coefficient data for the plurality of pixels is extracted, the film thicknesses at a plurality of positions in the two-dimensional region A can be calculated.

Thus, when the film thickness measurement of one measurement object 43 is completed, it is determined whether the measurement is to be continued under the conditions set at step S2 or completed at step S8. When the measurement is to be continued, the operation returns to step S5 and the film thickness of the measurement object 43 is measured, or when the measurement is to be completed, the data of the measured result is output to the display 34 and the input/output unit 35 at step S9 and the film thickness measurement is completed at step S10.

The basic constitution for measuring the two-dimensional film thickness of the film thickness measuring system 31 has been described above. Then, a description is made of a constitution for stabilizing the measurement result on the occasion of variation in distance or variation in inclination of the measurement object, which is a condition for performing inline measurement.

(Measures for Variation in Distance)

As shown n FIG. 8, in order to measure the two-dimensional image of the measurement object 43, it is necessary to use an imaging optical system in the receptor 40 of the sensor head 32. According to the film thickness measuring system 31 of the present invention, in order to stabilize the measurement precision on the occasion of variation in distance of the measurement object, a telecentric optical system is employed in the imaging optical system. The telecentric optical system is defined such that “when the aperture stop is positioned at a backward focal point position in an image space or positioned at a forward focal point position in an object space, all chief rays become parallel to the light axis in the object space or the image space, respectively, and therefore, since an error of the position of the object face or the image face has less impact on the error of the size of the image which is taken or measured, it is applied to the optical system which is strict on the error of the dimension measurement or magnification fluctuation of the object” (“Optical Technology Terminology Dictionary” written by Shuji Koyanagi and published by Optoelectronics Co., LTD.

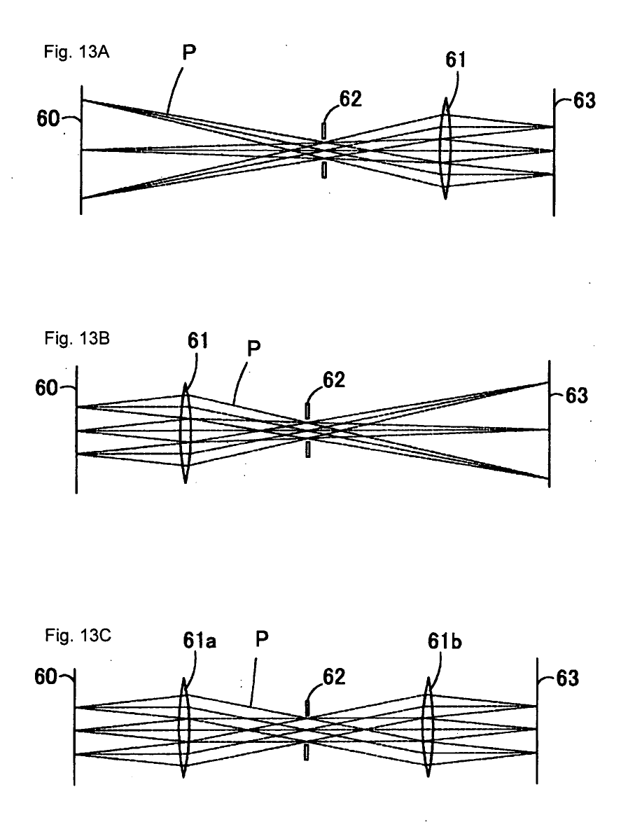

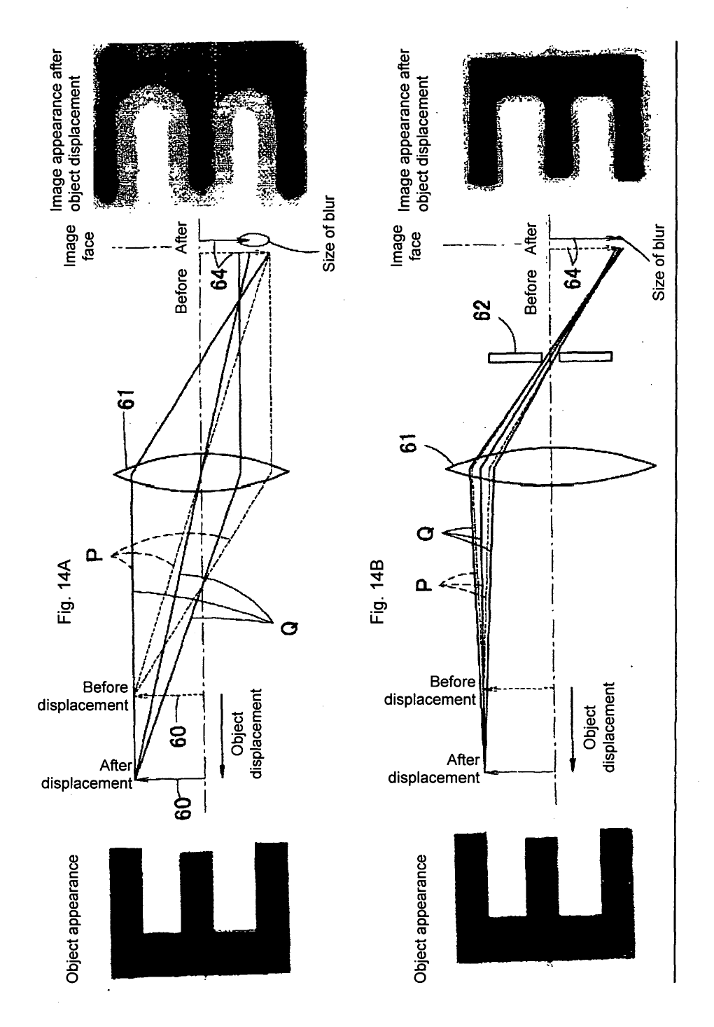

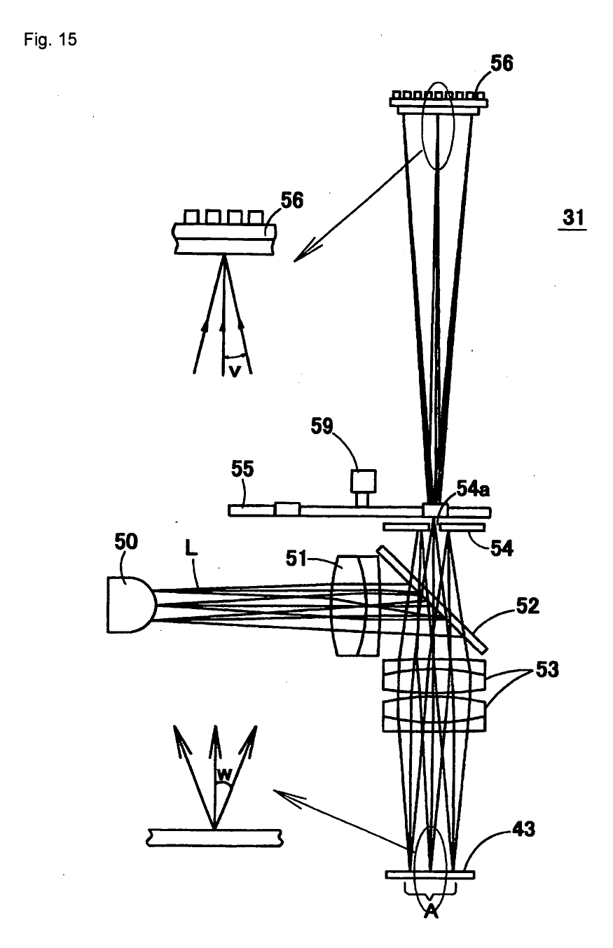

There are three kinds of optical systems in the telecentric optical system. FIG. 13A shows an explanatory view of a telecentric optical system on the image side, FIG. 13B is an explanatory view of a telecentric optical system on the object side, and FIG. 13C is an explanatory view of a telecentric optical system on both sides. According to the telecentric optical system on the image side, the aperture stop 62 is arranged at the focal point of the lens 61 on the object side in the object space between the object 60 and the lens 61 (forward focal point position), and the chief ray (passing through the center of the aperture stop) P is parallel to the lens light axis in the image space, so that even when the image face 63 is moved toward the direction of the lens light axis, the image only slightly changes. According to the telecentric optical system on the object side, the aperture stop 62 is arranged at the focal point of the lens 61 on the image side in the image space between the image face 63 and the lens 61 (backward focal point position), and the chief ray P is parallel to the lens light axis in the object space, so that even when the object 60 is moved toward the direction of the lens light axis, the image only slightly changes. According to the telecentric optical system on both sides, the focal point on the image side of a lens 61a positioned on the object side coincides with the focal point on the object side of a lens 61b positioned on the image side, and the aperture stop 62 is arranged at this focal point position, and the chief ray P is parallel to the lens light axis on the object side and on the image side, so that the image only slightly changes in either case the object 60 is moved toward the direction of the lens optical axis or the image face 63 is moved toward the direction of the lens light axis.

Since the film thickness measuring system 31 is integrally assembled, there is no problem in fluctuation of the image face (light receiving face). Therefore, since the telecentric optical system on the image side is not effective in stabilizing the measurement result on the occasion of the variation in distance of the measurement object, it is not appropriate here. Thus, according to the present invention, as the telecentric optical system, the telecentric optical system on the object side and the telecentric optical system on both sides are used.

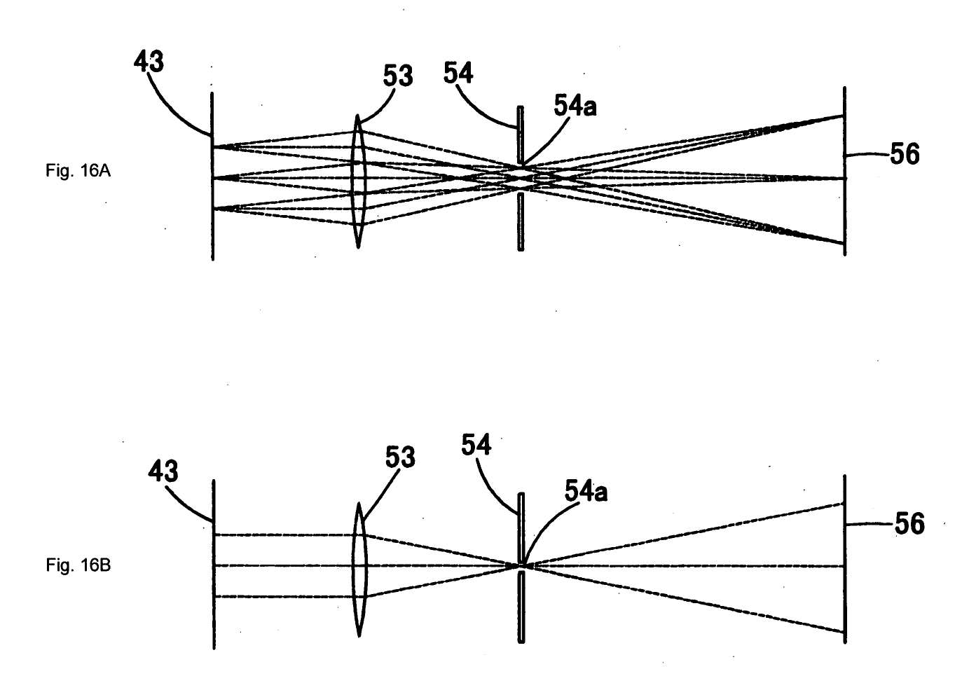

A description is made of a difference between a general imaging optical system and an imaging optical system using the telecentric optical system. FIG. 14A shows a view showing the general imaging optical system and the FIG. 14B shows a view showing the imaging optical system using the telecentric optical system on the object side. In each figure, there are shown an appearance of the object 60, a behavior of the chief ray and an appearance of the image 64 in the image face when the object is displaced and shifted from the imaging position. In addition, in the views of rays of light in the center of FIGS. 14A and 14B, the object 60 (before displacement) positioned at an optimum position to generate the focused image 64 on the image face is shown by a broken-line arrow, the object 60 (after displacement) positioned shifted from the above position is shown by a solid-line arrow, the chief ray output from the object 60 before displacement is shown by a broken line P, the chief ray output from the object 60 after displacement is shown by a solid line Q, the image 64 on the image face before the object 60 is displaced is shown by a broken line, the image 64 on the image face after the object is displaced is shown by a solid line, and a size of blur of the image is shown by an ellipse. According to the general imaging optical system shown in FIG. 14A, since the numerical aperture NA on the side of the object in the light-receiving optical system is large, when the object 60 is varied in distance, the magnification of the image 64 is varied, so that the size of the blur of the image 64 is increased. Meanwhile, according to the imaging optical system using the telecentric optical system on the object side shown in FIG. 14B, since the numerical aperture NA on the side of the object in the light-receiving optical system is very small and the chief rays P and Q are parallel to the lens light axis on the object side, even when the object 60 is varied in distance, the magnification of the image 64 is not varied and the size of the blur of the image 64 is small. As a result, it can be used for measuring the image with high precision.

Thus, according to the film thickness measuring system 31 of the embodiment 1, as shown in FIG. 8, the telecentric optical system on the object side is provided as the imaging optical system by arranging the small aperture 54a of the aperture stop 54 on the optical axis of the objective lens 53 in the vicinity of the lower face of the multi-spectral filter 55, between the objective lens 53 and the image-taking unit 56.

FIG. 15 shows a view showing an optical system in the film thickness measuring system 31 shown in FIG. 8 and its behavior. According to this film thickness measuring system 31, measuring light L emitted from the light source 50 passes through the projection lens 51, the half mirror 52 and the objective lens 53 and applied to the two-dimensional region A of the measurement object 43. The optical system for light projection is coaxial incident type in which light output toward the measurement object 43 is input onto the surface of the measurement object 43 in the almost perpendicular direction.

In addition, according to the optical system for light reception, the objective lens 53 comprises two couples of achromatic lenses, and the small aperture 54a of the aperture stop 54 is arranged at the focal point of the objective lens 53 on the image side to constitute the telecentric optical system on the object side by the objective lens 53 and the aperture stop 54. The measurement object 43 and the image-taking unit 56 are arranged such that the measurement object 43 and the light-receiving face of the image-taking unit 56 may be in the image-forming relation with respect to the objective lens 53. Thus, the measuring light L reflected by the predetermined two-dimensional region A passes through the telecentric optical system comprising the objective lens 53 and the aperture stop 54 and enters the multi-spectral filter 55. Thus, according to the film thickness measuring system 31, even when a distance between the film thickness measuring system 31 and the measurement object 43 is varied, the image of the measurement object 43 can be clearly formed in the image-taking unit 56, so that there is provided favorable characteristics for the distance variation of the measurement object 43.

According to the telecentric optical system, since the chief ray is parallel to the light axis of the lens, the magnification variation error is not generated even when the distance of the measurement object is varied and the image can be measured with high precision. However, it is necessary to suppress the variation in reflected light intensity to several % in order to measure the film thickness normally. That is, since in an image processing apparatus which searches a pattern and the like, it has only to identify an object image, slight variation in reflected light intensity of the image is allowed. Meanwhile, according to the film thickness measuring system 31 performing the two-dimensional measurement of the film thickness, since the variation in reflected light intensity of several % causes the measurement error, it is desired that the variation in reflected light intensity is almost nothing even when the distance of the measurement object is varied, or it is required that the variation in reflected light intensity is at least not more than several %.

In order to reduce the variation in reflected light intensity when the distance is varied, the numerical aperture NA on the object side in the light-receiving optical system is to be decreased (an aperture diameter of the aperture stop is to be reduced). Here, the numerical aperture NA on the object side in the light-receiving optical system is shown by:
numerical aperture NA on the object side in the light-receiving optical system=sin w
where a divergence angle of the measuring light L emitted from the measurement object 43 and passing through the aperture stop 54 is 2w (refer to FIG. 23B). In addition, since the numerical aperture NA on the image side in the light-receiving optical system is decided by the magnification of the light-receiving optical system and by the numerical aperture NA=sin w on the object side in the light-receiving optical system, in order to reduce the variation in reflected light intensity when the distance is varied, the numerical aperture NA on the image side in the light-receiving optical system is to be reduced. Here, the numerical aperture NA on the image side in the light-receiving optical system is designated by:
numerical aperture NA on the image side in the light-receiving optical system=sin v
where a divergence angle of the light limited by the aperture stop 54 and reaching the light-receiving face of the image-taking unit 56 is 2v as shown in FIG. 15.

That is, as shown in FIG. 16B, when the aperture diameter of the aperture stop 54 is narrowed to reduce the numerical aperture NA on the image side, since a flux of light passing through the aperture stop 54 becomes thin and the direction of the light which passed through the aperture stop 54 becomes parallel as compared with the case the aperture diameter of the aperture stop 54 is large as shown in FIG. 16A, the variation in reflected light intensity caused by the distance variation is reduced. However, when the numerical aperture NA on the object side in the light-receiving optical system is decreased too much by reducing the aperture stop, since the amount of light which passes through the aperture stop 54 is decreased, the image becomes dark and optical image resolution is lowered. Consequently, precision of a measurement position is lowered. For example, in a case a TFT array substrate is measured, when the optical resolution is almost equal to a pixel pitch, it is highly likely that a black matrix region is measured in order to measure the film thickness in the pixel aperture. Therefore, according to the film thickness measuring system 31, it is necessary to obtain an optimum value of the numerical aperture NA=sin w on the object side in the light-receiving optical system (or the aperture diameter of the aperture stop 54) so as to reduce the variation in reflected light intensity as much as possible when the distance is varied, within a range in which the optical image resolution of the light-receiving optical system may not be lowered too much.

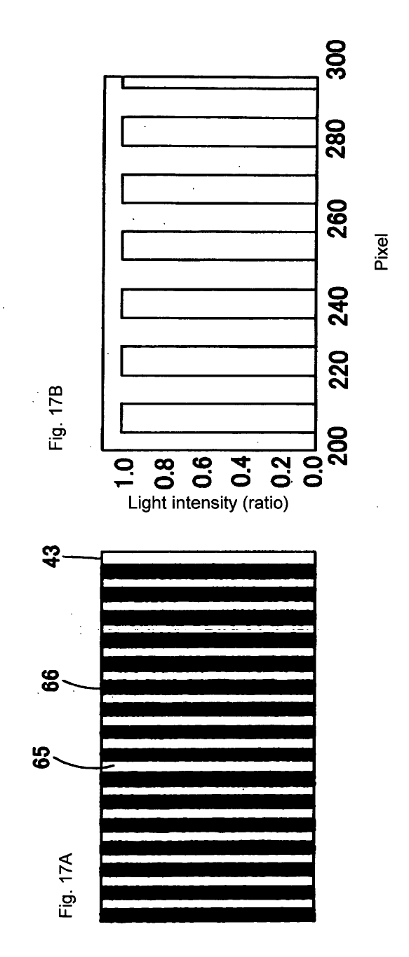

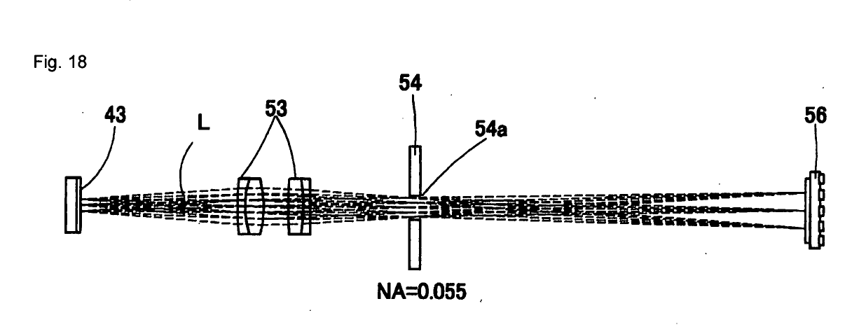

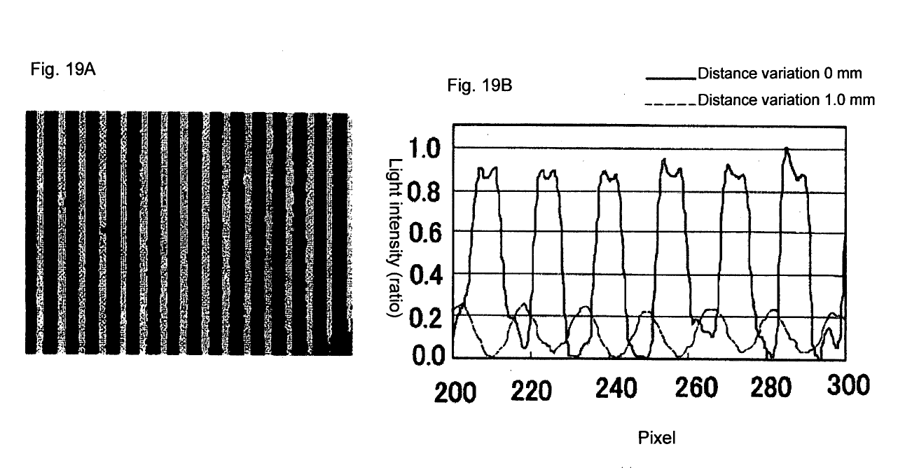

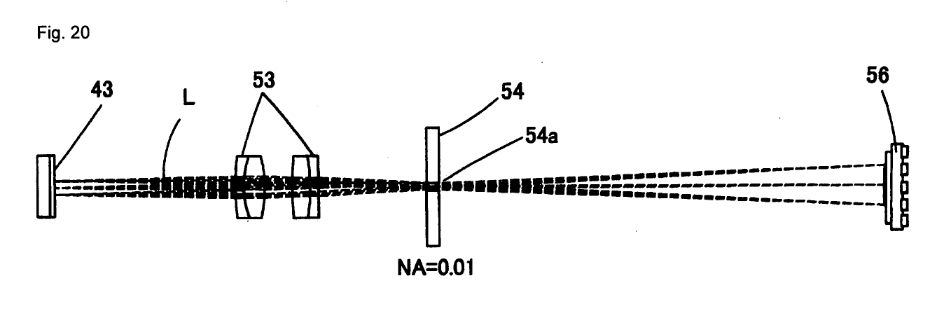

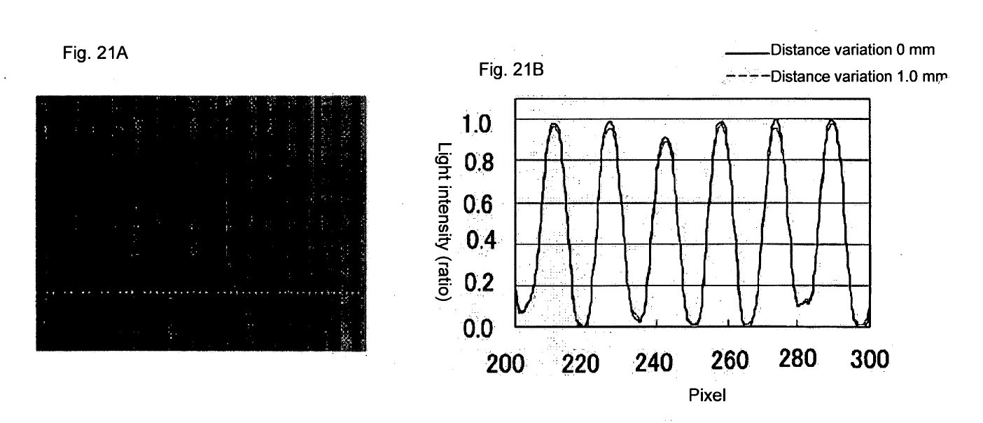

Next, a description is made of a method of experimentally deciding the aperture diameter of the aperture stop 54 using an image evaluating sample. FIG. 17A is a plan view showing a measurement object 43 (sample) used in this experiment. This measurement object 43 is called ronchi ruling (EDMUND OPTICS JAPAN CO., LTD) which is a pattern in which parallel lines are aligned regularly and a line width and a space width are the same, and used as the measurement object for image evaluation such as resolving power or distortion in the imaging optical system. In this experiment, the ronchi ruling is used, in which stripes 66 (dark parts in FIG. 17A) are formed by evaporating chrome on a surface of a transparent substrate 65 such as a glass substrate and a line width of the pattern is about 41 μm (space frequency 12/mm). FIG. 17B shows a waveform chart (image chart) of the light intensity when it is assumed that the measurement object 43 is directly read by the image-taking unit 56, in which a vertical axis shows the light intensity in which its maximum is 1, and a lateral axis shows pixel numbers (pixel positions) of the image-taking unit 56. In addition, FIG. 18 is a schematic view showing the telecentric optical system on the object side of 3 optical magnifications, using an aperture stop 54 (aperture diameter is 3 mm) so that the numerical aperture NA on the object side in the light-receiving optical system becomes 0.055, FIGS. 19A and 19B are views each showing an image and waveforms, in which the ronchi ruling is observed as the measurement object 43 using the telecentric optical system shown in FIG. 18. In addition, FIG. 20 is a schematic view showing a telecentric optical system on the object side comprising objective lens of 3 magnifications, using a aperture stop 54 (aperture diameter is 0.5 mm) so that the numerical aperture NA on the object side in the light-receiving optical system becomes 0.01, and FIGS. 21A and 21B show views each showing an image and waveforms, in which the ronchi ruling is observed as the measurement object 43 using the telecentric optical system shown in FIG. 19. In addition, the waveforms shown in FIG. 19B and FIG. 21B each show variations in the direction in which a pattern of the image of the measurement object is varied, and distance variations of the measurement object is 0 mm (imaging position) and 1.0 mm. In addition, in FIG. 19B and FIG. 21B, the vertical axis shows the reflected light intensity and the lateral axis shows the pixel number (pixel position).

When the image and the waveforms in FIGS. 19A and 19B are compared with those in FIGS. 21A and 21B, according to the image in FIG. 19A when the aperture diameter of the aperture stop 54 is large, it is shown that an edge is clear and image resolution is better as compared with the image in FIG. 21A in which the aperture diameter of the aperture stop 54 is small. However, according to the waveforms when the distance is varied in FIG. 19B, it is shown that the variation in light intensity is great when the distance is varied, so that the distance variation characteristic is not good. According to FIGS. 21A and 21B, although the image resolution is not good, the variation in light intensity when the distance is varied is very small and the distance variation characteristic is good. Thus, since the image resolution and the distance variation characteristic are in a conflicting relation, it is difficult to decide the aperture diameter of aperture stop so as to satisfy both of them. Therefore, in order to decide the optimum value of the numerical aperture NA on the image side and the aperture diameter of the aperture stop 54 in the telecentric optical system, it is necessary to select either one of a method in which the distance variation characteristic is uniquely decided after a desired optical image resolution is decided, or a method in which the image resolution is uniquely decided after a desired distance variation characteristic is decided. In addition, although the description was made of the case the telecentric optical system on the object side in the above embodiment, the telecentric optical system on both sides can be also used in the film thickness measuring system 31.

It is found in the experiment that the numerical aperture NA on the object side in the light-receiving optical system is to be 0.02 or less in order to reduce the variation in reflected light intensity when the measurement object is varied in distance, to acceptable degrees in view of measurement precision. Therefore, when the measurement object is such that a thin film is uniformly formed on an entire surface of a substrate, since there is no problem in the image resolution of the film thickness measuring system, it is desirable that the numerical aperture NA on the object side in the light-receiving optical system is reduced as small as possible, that is, to 0.02 or less. However, when the measurement object is such that fine patterns are formed like a TFT array substrate, the measurement point cannot be precisely designated when the numerical aperture NA on the object side in the light-receiving optical system is too small. Thus, in this case, a lower limit value is set in the numerical aperture NA on the object side in the light-receiving optical system and as the fine pattern becomes fine, the lower limit value is increased. Thus, when the optimal size of the aperture stop is experimentally decided according to the fineness of the pattern, the optimal value of the numerical aperture NA on the object side in the light-receiving optical system can be found.

(Measures for Inclination Variation Characteristic)

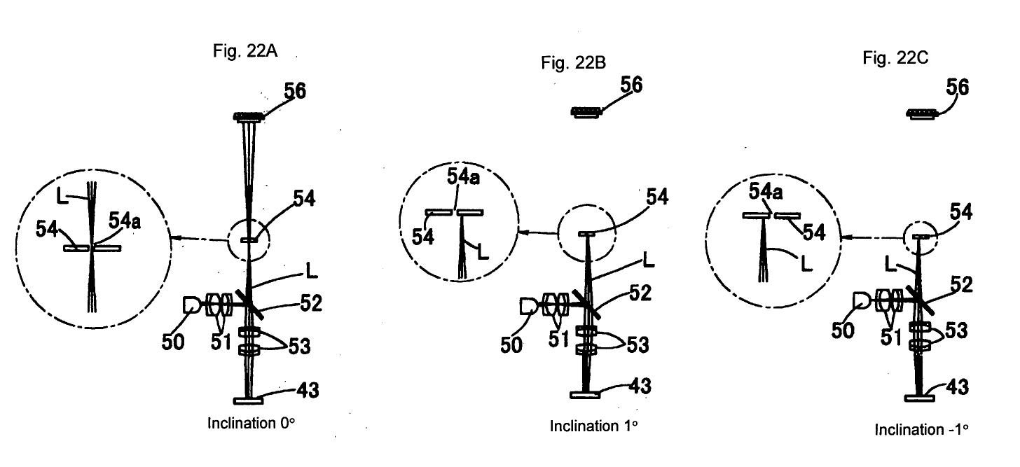

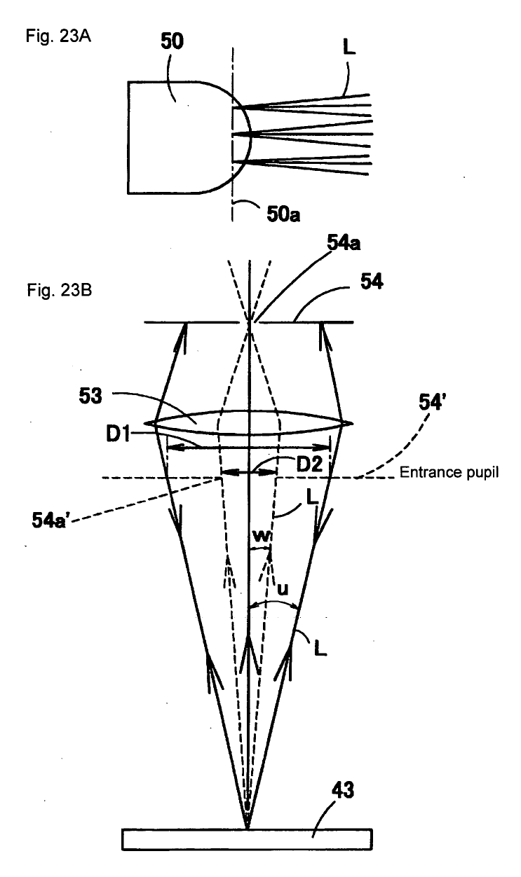

According to the film thickness measuring system 31 of the present invention, although the telecentric optical system which is immune to the distance variation of the measurement object is employed as the imaging optical system, when the inclination of the measurement object is varied, the reflected light from the measurement object 43 is interrupted by the aperture stop 54 and the measurement object 43 cannot be observed at the image-taking unit 56, so that the film thickness cannot be measured only with the telecentric optical system. That is, although the light reflected at the two-dimensional region A of the measurement object 43 passes through the small aperture 54a and reaches the image-taking unit 56 when the inclination of the measurement object 43 is 0° as shown in FIG. 22A, when the measurement object 43 is inclined ±1° as shown in FIG. 22B or 22C, the light reflected at the two-dimensional region A is interrupted by the aperture stop 54 and cannot be observed at the image-taking unit 56.

Thus, according to the present invention, in order to reduce deterioration of the precision of the film thickness measurement caused by inclination variation of the measurement object 43, the following two constitutions are employed for the light-receiving/projecting optical system. First, as shown in FIG. 15, the light-projecting optical system is constituted by a coaxial incident optical system, and the optical system is constituted such that the numerical aperture NA on the image side (on the measurement object side) in the light-projecting optical system may be larger than the numerical aperture NA on the object side (on the measurement object side) in the light-receiving optical system which is decided by the aperture diameter of the aperture stop 54. Here, the numerical aperture NA on the image side in the light-projecting optical system is designated by:
numerical aperture NA on the image side in the light-projecting optical system=sin u
   where a divergence angle of the measuring light L applied from the light source 50 to the measurement object 43 through the light-projecting optical system is 2u. If the measurement object 43 is a mirror-surface object, the divergence of the light reflected by the measurement object 43 is decided by the numerical aperture NA on the image side in the light-projecting optical system. In addition, the numerical aperture NA on the object side in the light-receiving optical system is designated by
numerical aperture NA on the object side in the light-receiving optical system=sin w
   where a divergence angle of the measuring light L which is output from the measurement object 43 and passes through the aperture stop 54 is 2w. As shown in FIG. 23B, this divergence angle can be also referred to as an angle formed by a small aperture 54a′ of an entrance pupil 54′ envisioned from the aperture stop 54 and a point on the measurement object 43.

Secondly, a certain face (this face is referred to as a light-source reference face 50a hereinafter) of the light source 50 and the aperture stop 54 are provided so as to be in the image-forming relation, and as shown in FIG. 23A, the distribution of the outgoing light is to be uniform in an appropriate size of region in the light-source reference face 50a. The uniform distribution of the outgoing light device that the outgoing light amount is uniform on the entire light-emitting region of the light-source reference face 50a or a directional pattern is the same.

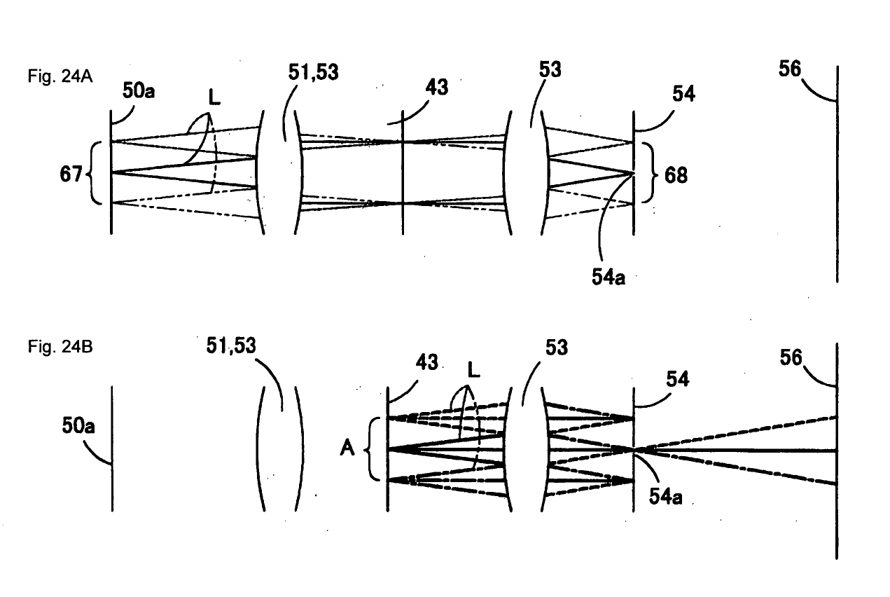

Thus, according to this optical system, as shown in FIG. 24A, the light-source reference face 50a and the aperture stop 54 are in the image-forming relation, and the measuring light L output from each light point of a light-emitting region 67 of the light-source reference face 50a passes through the projection lens 51 and the objective lens 53, coaxially reaches the measurement object 43, diverges on the whole of the two-dimensional region A, passes through the objective lens 53 again, and provides the image in a face of the aperture stop 54. In addition, as shown in FIG. 24B, the measuring light L reflected by each point in the two-dimensional region A of the measurement object 43 diverges on the whole of the region of the image of the light-emitting region 67 in the aperture stop 54 (that is, an illumination region 68 in the aperture stop 54). In addition, since distribution of the outgoing light amount is uniform on the whole of the light-emitting region 67 of the light-source reference face 50a, the light amount distribution is uniform on the whole illumination region 68 of the aperture stop 54. In addition, FIGS. 24A and 24B show conceptual views in which the ray of light moves in one direction.

In addition, although the numerical aperture NA on the image side in the light-projecting optical system is larger than the numerical aperture NA on the object side in the light-receiving optical system, since divergence of the incident light to the measurement object 43 is equal to divergence of the light reflected by the measurement object 43 in the mirror-face measurement object 43, this condition device that as shown in FIG. 23B, a spot diameter D1 of the light in which the light reflected by the measurement object 43 is applied onto the entrance pupil 54′ corresponding to the aperture stop 54 is larger than a aperture diameter D2 of the small aperture 54a′ of the entrance pupil 54′. Therefore, the light reflected by the measurement object 43 is applied onto the aperture stop 54 as the spot light having an area larger than that of the small aperture 54a (refer to FIG. 24B). Especially, the size of the illumination region 68 in the aperture stop 54 is provided such that even when the measurement object 43 is inclined by an assumed maximum amount, the small aperture 54a may not protrude from the illumination region 68. Thus, the area of the light-emitting region 67 of the light-source reference face 50a corresponds to that size. Furthermore, since the measurement object 43 and the image-taking unit 56 are in the image-forming relation, the measuring light L output from the two-dimensional region A of the measurement object 43 diverges on the whole illumination region 68 in the aperture stop 54 and a part of them passes through the small aperture 54a of the aperture stop 54 to provide an image at the image-taking unit 56.

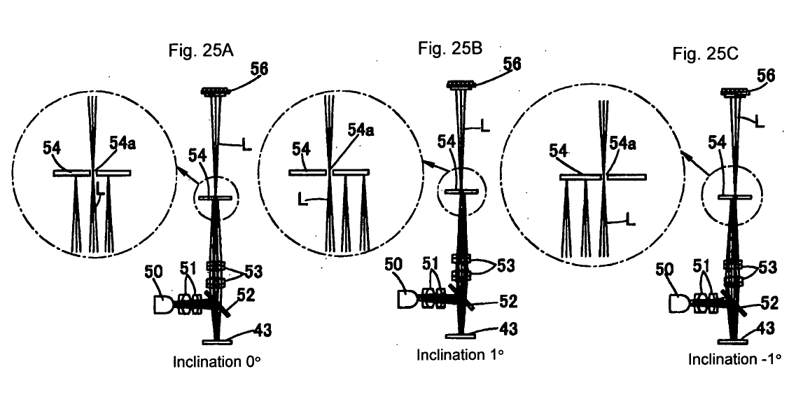

Thus, as shown in FIG. 25A, when the inclination of the measurement object 43 is 0°, the measuring light L reflected by the two-dimensional region A of the measurement object 43 passes through the small aperture 54a to provide the image at the image-taking unit 56, and as shown in FIGS. 25B and 25C, even when the measurement object 43 is inclined ±1°, the measuring light L reflected by the two-dimensional region A passes through the small aperture 54a to provide the image at the image-taking unit 56. Thus, even when the inclination of the measurement object 43 is varied, the measurement object 43 can be observed at the image-taking unit 56.

Thus, although the film thickness of the thin film can be measured even when the inclination of the measurement object 43 is varied, if the reflected light intensity observed at the image-taking unit 56 is varied because of the inclination of the measurement object 43, the film thickness can not be correctly measured.

Therefore, according to the film thickness measuring system 31, since the distribution of the outgoing light amount is uniform in the light-emitting region 67 of the light-source reference face 50a, and as shown in FIG. 24A since the measuring light L output from each point in the light-emitting region 67 diverges on the whole two-dimensional region A, the light amount distribution is uniform on the whole two-dimensional region A of the measurement object 43. Furthermore, since the image of the light-emitting region 67 is provided at the aperture stop 54, the light amount distribution is uniform in the illumination region 68 of the aperture stop 54. Thus, even when the measurement object 43 is inclined and a light region received at the image-taking unit 56 is varied, the reflected light intensity observed at the image-taking unit 56 is not varied. As a result, even when the inclination of the measurement object 43 is varied, the film thickness can be measured with high precision.

As can be clear by the above description, according to the film thickness measuring system 31 of this embodiment 1, even when the distance or the inclination is varied, the film thickness can be measured, and even when the distance or the inclination is varied, the reflected light intensity observed at the image-taking unit 56 is almost constant, so that the film thickness can be measured with high precision.

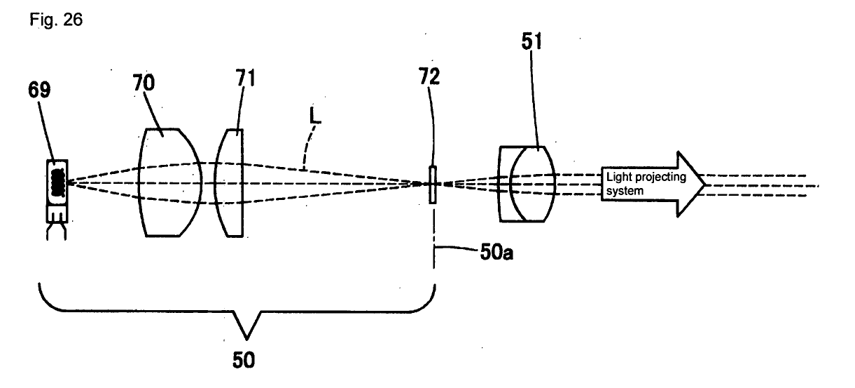

Although the distribution of the outgoing light amount is uniform in the light-emitting region 67 of the light-source reference face 50a (that is, the face which is in the image-forming relation with the aperture stop 54) in the light source 50, a method of implementing such light source 50 is described. FIG. 26 is one example of the light source 50, in which measuring light L output from a lamp 69 passes through condenser lenses 70 and 71, and then reaches a diffusion plate 72 having a relatively small diffusion angle. Thus, the distribution of the outgoing light amount is made to be uniform by diffusing the measuring light L at the diffusion plate 72. According to this light source 50, the face on which the diffusion plate 72 is provided is the light-source reference face 50a.

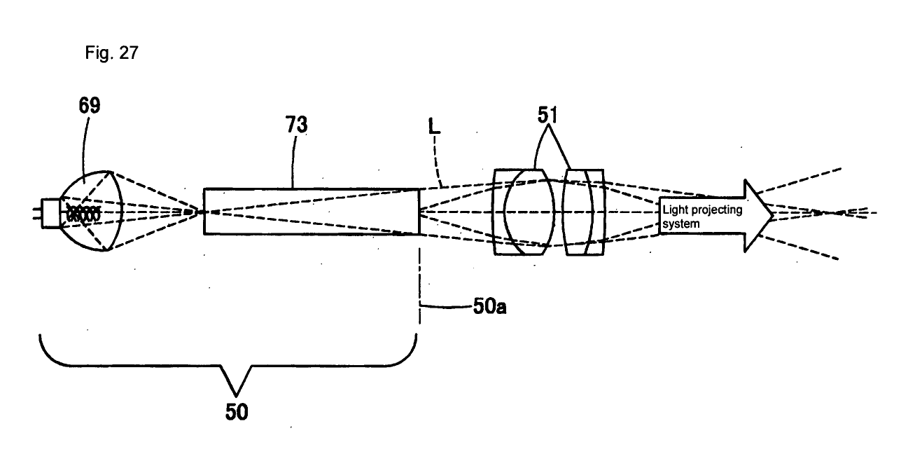

FIG. 27 shows another light source 50 which is constituted by a lamp 69 and a rod lens 73. According to this light source 50, the distribution of the outgoing light amount is made to be uniform by the rod lens and a light-outgoing side of an end face of the rod lens 73 is the light-source reference face 50a.

(Variation)

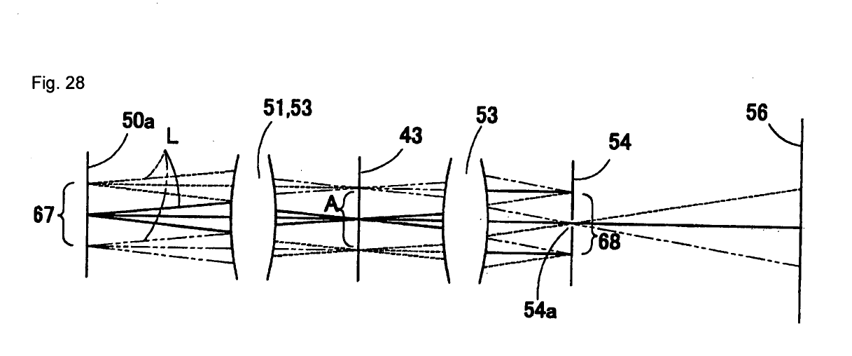

FIG. 28 shows a variation of the embodiment 1 and shows a conceptual view in which a ray of light moves toward one direction like in FIGS. 24A and 24B. In this variation also, an aperture stop 54 is positioned at a backward focal point of an objective lens 53 and an imaging optical system is the telecentric optical system on the object side, and a measurement object 43 and an image-taking unit 56 are in the image-forming relation. In addition, in a light source 50, distribution of an outgoing light amount is uniform in a light-emitting region 67 of a light-source reference face 50a, a light-projecting part is constituted by a coaxial incident optical system, and an optical system is constituted such that the numerical aperture NA on the image side in the light-projecting optical system may be larger than the numerical aperture NA on the object side in a light-receiving optical system. A different point is that instead of the aperture stop 54, the light-source reference face 50a is in an image-forming relation with the measurement object 43.

According to this variation, the distribution of the outgoing light amount is uniform in the light-emitting region 67 of the light-source reference face 50a, and the measuring light L output from the light-emitting region 67 provides an image at the measurement object 43. Thus, the light amount distribution is uniform in the two-dimensional region A of the measurement object 43. In addition, the measuring light L reflected at each point of the two-dimensional region A diverges in a whole illumination region 68 of the aperture stop 54 and therefore, the distribution of the light amount is uniform in the whole illumination region 68. Thus, in this constitution also, even when the inclination of the measurement object 43 is varied, the measurement object 43 can be observed at the image-taking unit 56, and when the inclination is varied, reflected light intensity observed at the image-taking unit 56 is almost constant and the film thickness can be measured with high precision.

Thus, in this variation also, even when the distance or the inclination is varied, the film thickness can be measured, and even when the distance or the inclination is varied, the reflected light intensity observed at the image-taking unit 56 is almost constant, so that the film thickness can be measured with high precision.

### Embodiment 2

FIG. 29 shows a schematic view showing an optical constitution of a sensor head 32 of a film thickness measuring system according to an embodiment 2. According to the sensor head 32, an objective lens 53 is arranged over a half mirror 52 and after an objective lens 53 is detached from a light-projecting part and measuring light L output from a light source 50 passes through a projection lens 51, it is reflected by the half mirror 52 and coaxially reaches the measurement object 43. Although the objective lens 53 is arranged over the half mirror 52 in a light-receiving part, this embodiment is the same as the embodiment 1 in that a aperture stop 54 is arranged at a backward focal point of the objective lens 53 to provide the telecentric optical system on the object side, and the measurement object 43 and the image-taking unit 56 are in the image-forming relation with respect to the objective lens 53.

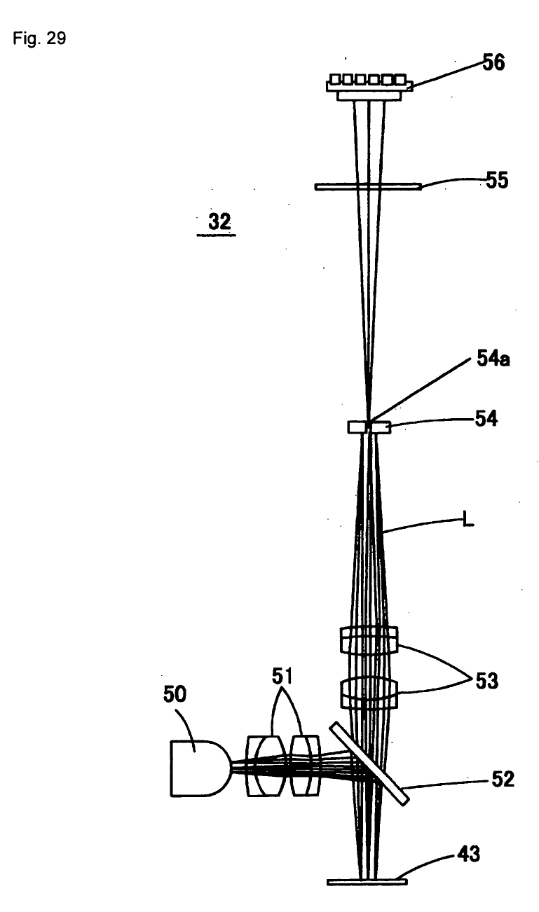

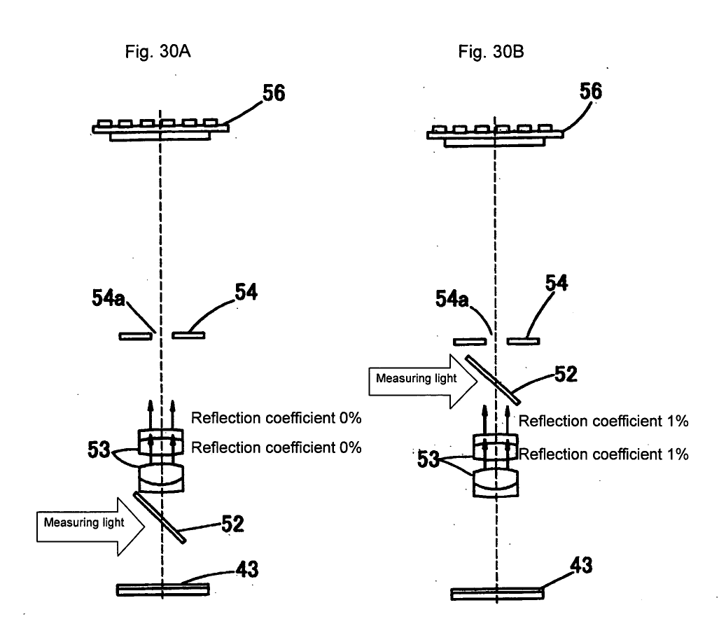

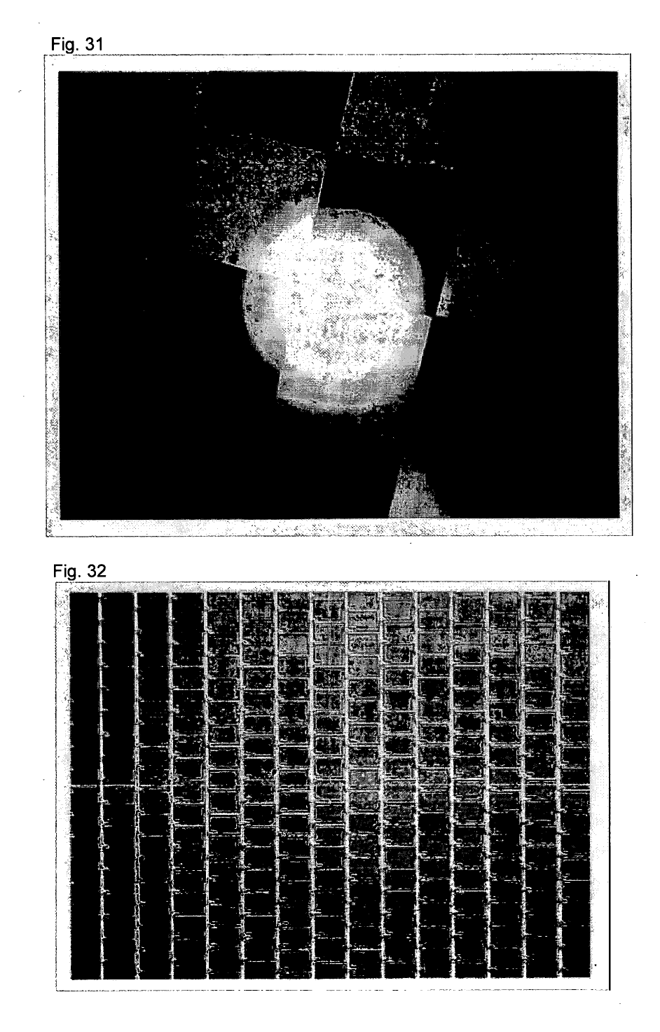

Since the objective lens 53 is positioned under the half mirror 52 in order to miniaturize the imagine optical system in the film thickness measuring system 31 according to the embodiment 1, the objective lens 53 is positioned between the light source 50 and the measurement object 43. Therefore, as shown in FIG. 30B, the measuring light L of about 1% of the measuring light L applied from the light source 50 to the measurement object 43 (an AR coating is provided on the lens surface and reflected light from one surface is 0.5% and from both surfaces is 1.0%. When the objective lens 53 is constituted by two lenses as illustrated, the reflected light becomes 2% in total) is reflected by the objective lens 53 and observed at the image-taking unit 56 as disturbance light. FIGS. 31 and 32 show that examples. That is, FIG. 31 shows an image of drafting paper and FIG. 32 shows an image of a TFT array substrate. In both images, light intensity is high at the center and an influence of the reflected light from the objective lens 53 is shown.

The influence of the disturbance light from the objective lens 53 lowers a dynamic range of the image-taking unit 56, in a case of measurement of an object having a small reflection coefficient such as pattern measurement on a glass substrate. In order to measure spectral reflection coefficient by the film thickness measuring system with high precision, it is necessary to minimize such influence of the disturbance light.

Meanwhile, according to the sensor head 32 in the embodiment 2, since the objective lens 53 is positioned above the half mirror 52 and the light source 50 is arranged between the objective lens 53 and the measurement object 43, as shown in FIG. 30A, the measuring light L applied from the light source 50 to the measurement object 43 is not reflected by the objective lens 53. Therefore, according to the sensor head 32 of the embodiment 2, an influence of the reflected light from the objective lens 53 can be suppressed and a two-dimensional spectral reflection coefficient can be measured with high precision, so that the film thickness can be measured with high precision.

In addition, in both optical system of the second embodiment 2 shown in FIG. 30A and optical system of the embodiment 1 shown in FIG. 30B, the light source 50 is arranged between the aperture stop 54 and the measurement object 43, and the optical axis of the light-projecting optical system and the optical axis of the light-receiving optical system are coaxial only on the side of the measurement object of the aperture stop 54. Therefore, the measuring light L output from the light source 50 toward the measurement object 43 is not limited by the aperture stop 54 before it reaches the measurement object, so that the aperture stop 54 does not prevent the numerical aperture NA on the image side in the light-projecting optical system from becoming larger than the numerical aperture NA on the object side in the light-receiving optical system.

In addition, in the film thickness measuring system 31 of the present invention, a cube type of beam splitter 74 as shown in FIG. 33A can be used instead of the half mirror 52. However, when the beam splitter 74 is used as shown in FIG. 33A, reflected light 75 is generated on each surface of the beam splitter 74 and about 1% of the reflected light from the surface is observed at the image-taking unit 56 as disturbance light. For example, in a case the measurement object 43 is a glass substrate, since its reflection coefficient is about 4%, when such disturbance light is input to the image-taking unit 56, a dynamic range is considerably lowered.

Meanwhile, when the half mirror 52 is used, as shown in FIG. 33B, since reflected light is not generated on the surface unlike in the beam splitter 74, disturbance light does not enter the image-taking unit 56. Therefore, in order to coaxially apply the measuring light L from the light source 50 to the measurement object 43, the half mirror 52 is preferably used. However, when the half mirror 52 is used, an influence of a ghost appears because of reflection on a reflection face and an opposite face of the reflection face, or when the half mirror 52 is thick, since the imaging positions are different between a vertical side and a lateral side in the image, optical resolution could be lowered. However, the above problems can be solved by using a half mirror having a thin thickness such as a pellicle beam splitter (thickness is 2 μm: EDMUND OPTICS JAPAN CO., LTD).

Next, a description is made of an example in which the characteristics are optimized so that measurement precision may be stabilized on the occasion of distance variation of ±0.5 mm or inclination variation of ±0.5°, in a case a spectral reflection coefficient of a pixel of 40 μm in a liquid crystal display panel is measured using a film thickness measuring system provided with a sensor head 32 having the structure shown in FIG. 29. That is, in this case, it is necessary to select a fine spot having a diameter of 40 μm which can be fit in a pixel aperture, from the measurement object 43 and measure the film thickness in the spot. In addition, it is necessary to adjust the numerical aperture NA and the like so that film thickness can be measured with high precision even when the distance of the measurement object 43 is varied ±0.5 mm or inclination thereof is varied ±0.5°.

In order to obtain the above characteristics, according to this film thickness measuring system, an optical magnification is set at 3, an aperture diameter of the aperture stop 54 is set at 1 mm, a numerical aperture NA on the image side in the light-projecting optical system is set at 0.00235 to 0.04 or more, a numerical aperture NA on the object side in the light-receiving optical system is set at 0.006 to 0.02, and a numerical aperture NA on the image side in the light-receiving optical system is set at 0.002 to 0.0073 so that the numerical aperture NA on the image side in the light-projecting optical system may be larger than the numerical aperture NA on the object side in the light-receiving optical system. Here, the reason why the upper limit value of the numerical aperture NA on the object side in the light-receiving optical system is set at 0.02 is that if it is more than 0.02, the variation in light intensity on the occasion of distance variation becomes too great, and the reason why the lower limit value is set at 0.006 is that if it is less than 0.006, image resolution is lowered and the pixel cannot be specified.

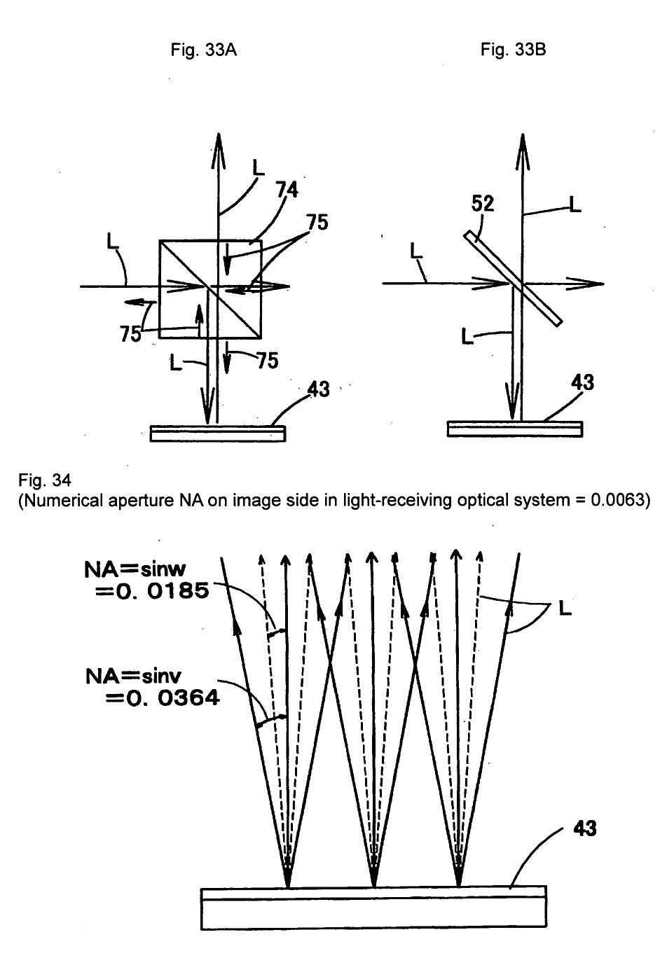

FIG. 34 shows the most optimal example, in which the numerical aperture NA on the object side in the light-receiving optical system is set at 0.0185 (divergence angle 2u of measuring light=2.3°) and the numerical aperture on the image side in the light-receiving optical system is set at 0.0063. Although the numerical aperture NA on the image side in the light-projecting optical system has only to be more than 0.0185, it is preferably set at 0.0364. Thus, the film thickness can be measured with high precision even when the measurement object 43 is varied in distance by ±0.5 mm.

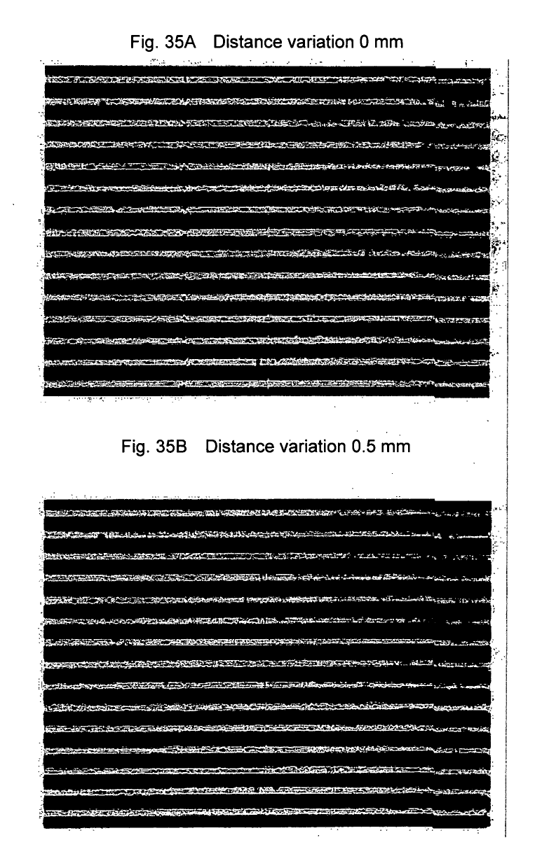

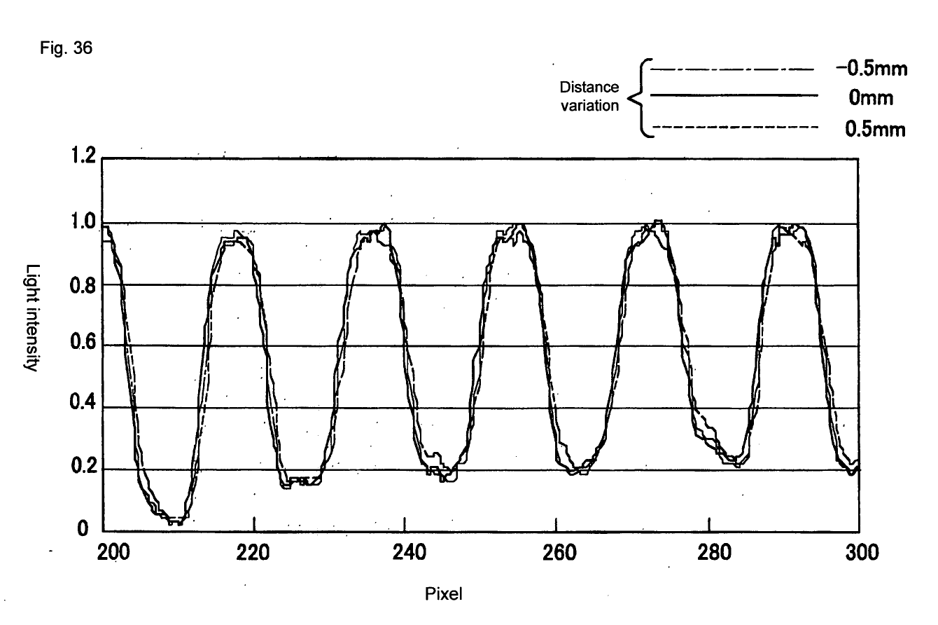

FIG. 35A, 35B and FIG. 36 show results from measuring a ronchi ruling having a line width of 41 μm by the film thickness measuring system. FIG. 35A shows an image when the distance variation of the measurement object 43 is 0 mm (imaging position), and FIG. 35B shows an image when the distance variation is 0.5 mm. In addition, FIG. 36 show a waveform chart showing a variation in light intensity along the direction in which the pattern of the ronchi ruling is varied, in the case the distance variation of the measurement object 43 is 0 mm and the case the distance variation thereof is ±0.5 mm. From these results, it is shown that even when the distance of the measurement object 43 is varied about ±0.5 mm, the variation in light intensity is small and the line width of 41 μm is resolved to provide the image.

Thus, it is shown that this film thickness measuring system having the above values is suitable for inline-measuring the film thickness in the pixel of 40 μm in a flat panel display.

### Embodiment 3

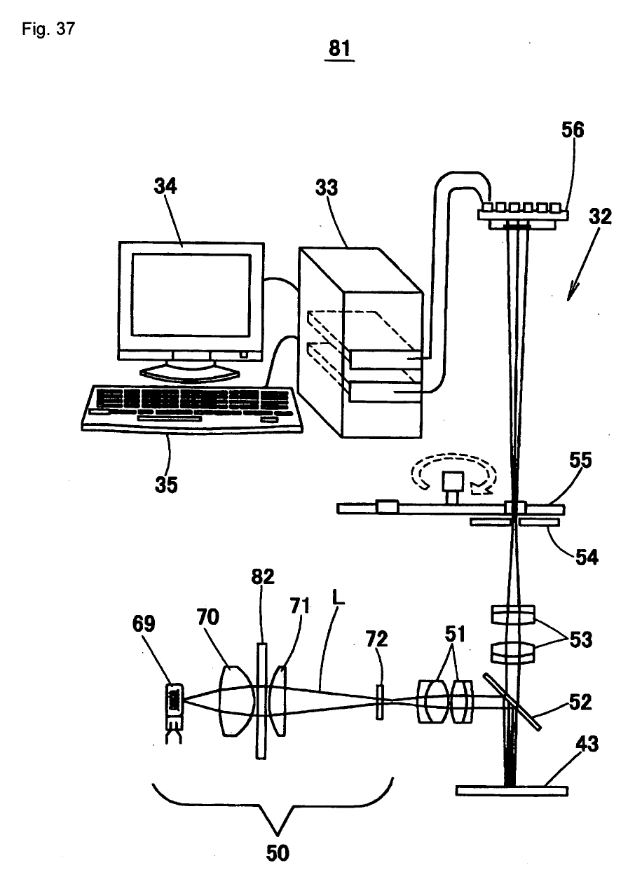

FIG. 37 shows a schematic view showing a constitution of an optical system of a film thickness measuring system 81 according to an embodiment 3 of the present invention. According to the embodiment 3, the constitution shown in FIG. 26 is used as a light source 50, and a heat-absorber filter 82 which cuts light in an infrared region and protects a condenser lens 71 or an diffusion plate 72, is provided between the condenser lenses 70 and 71. In addition, according to a light-receiving optical system, objective lenses 53 are provided above a half mirror 52 like in the embodiment 2.

According to this embodiment, the followings are set.
Numerical aperture NA on an image side in a light-projecting optical system=0.0364
Numerical aperture NA on an object side in a light-receiving optical system=0.0185
Numerical aperture NA on the image side in the light-receiving optical system=0.0063

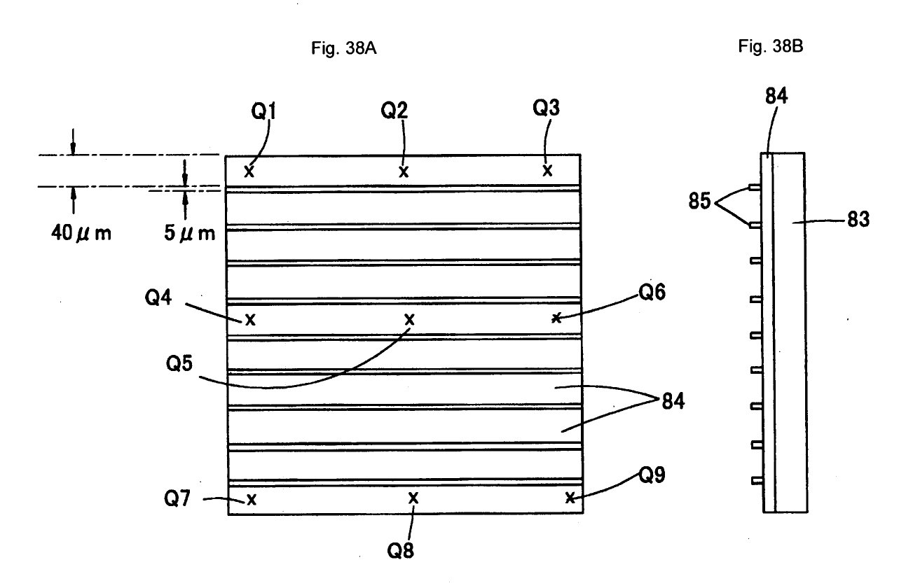

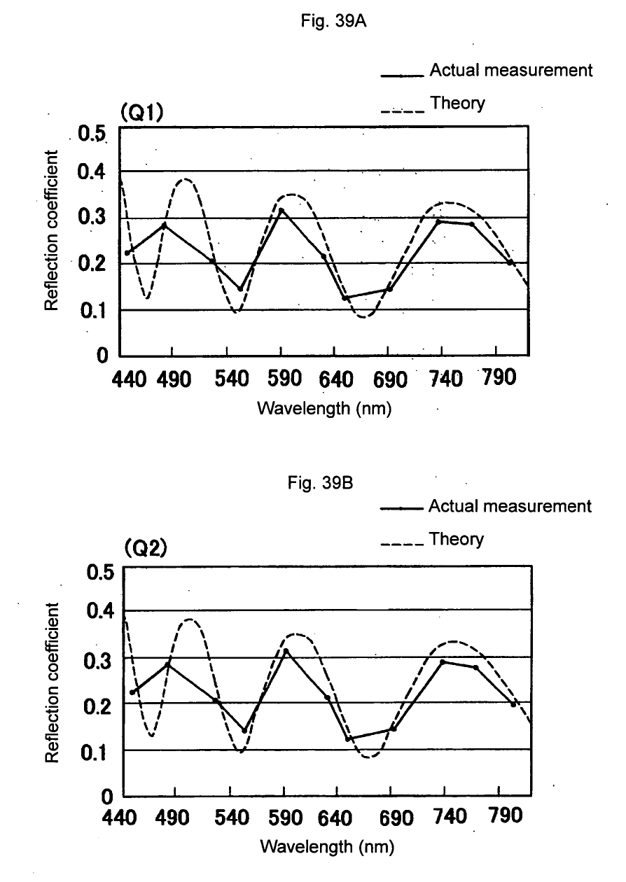

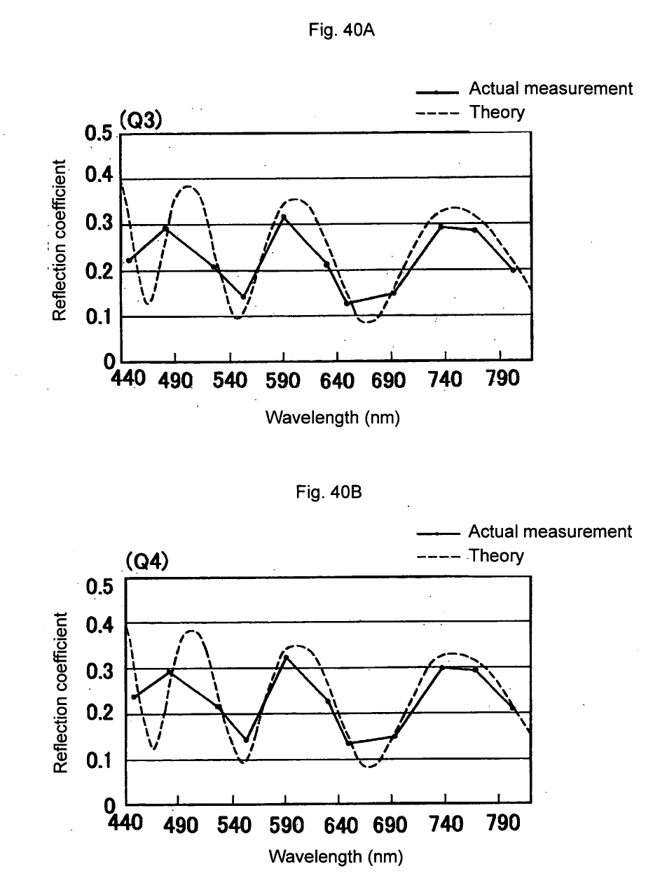

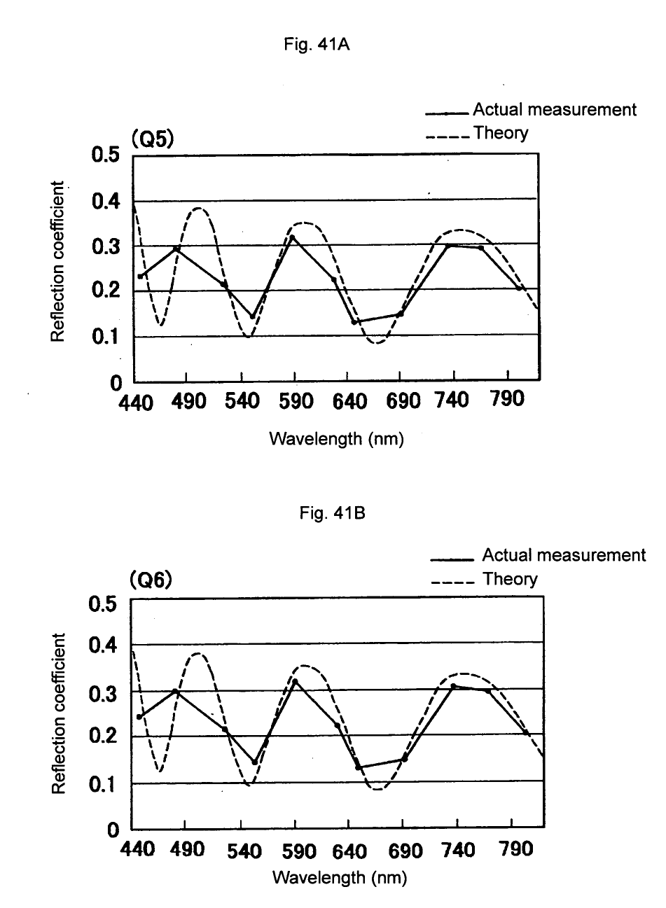

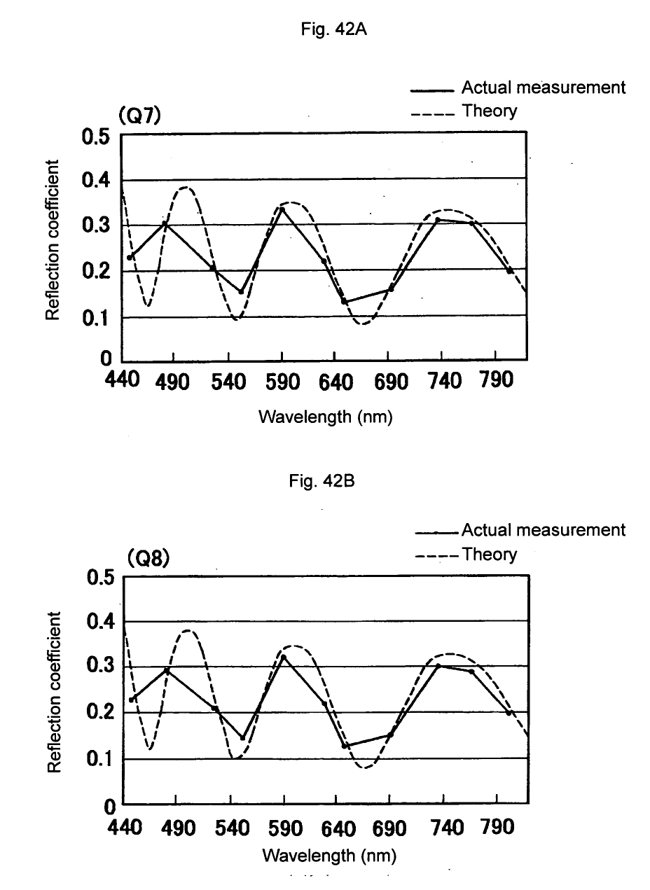

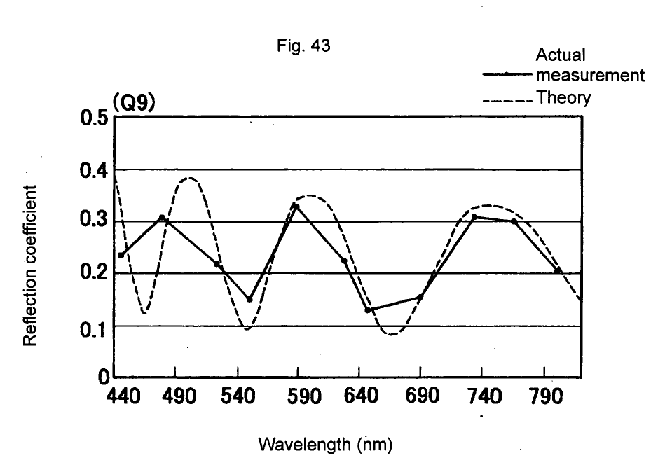

FIGS. 38 to 49 are views for explaining a result from measuring a measurement object arranged at an imaging position by the film thickness measuring system 81. FIGS. 38A and 38B are a plane view and a side view of a sample used in the measurement, respectively, in which an SiO₂ film 84 having a film thickness of 1000 nm is formed on a surface of an Si substrate 83 and resists 85 each having a width of 5 μm are patterned at intervals of 40 μm. FIG. 39A, 39B, FIG. 40A, 40B, FIG. 41A, 41B, FIG. 42A, 42B, and FIG. 43 show results (solid-line waveforms) from measuring spectral reflection coefficients of the SiO₂ film 84 between the resists 85 at points Q1 to Q9 shown in FIG. 38A, and theoretical spectral reflection coefficients (broken-line waveforms). Since eleven spectral filters 57a, 57b . . . of a multi-spectral filter 55 are used in this experiment, the spectral reflection coefficients are plotted for eleven wavelengths. From FIGS. 39A to 43, it is shown that the spectral reflection coefficients can be favorably measured at points Q1 to Q9 in the sample surface.

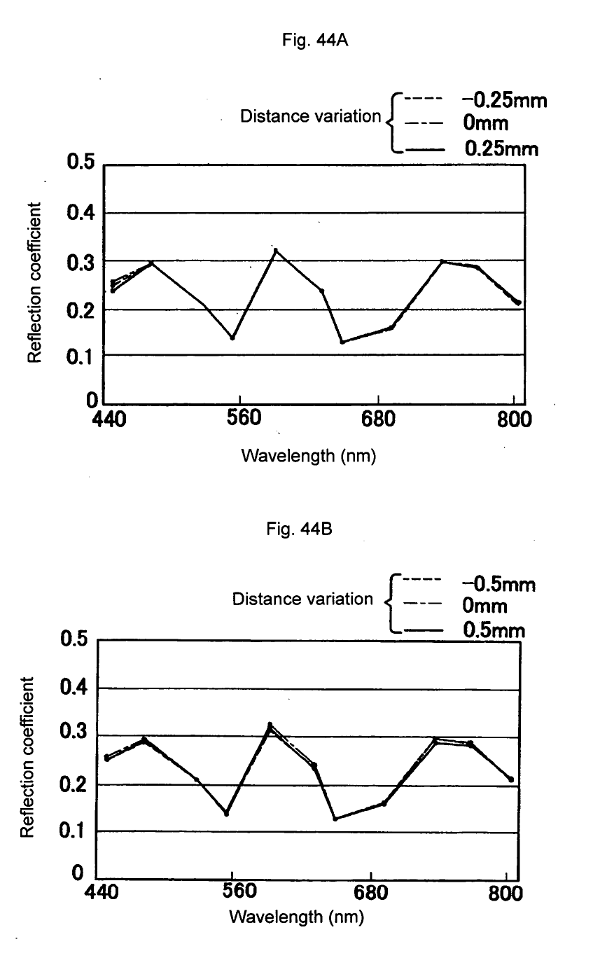

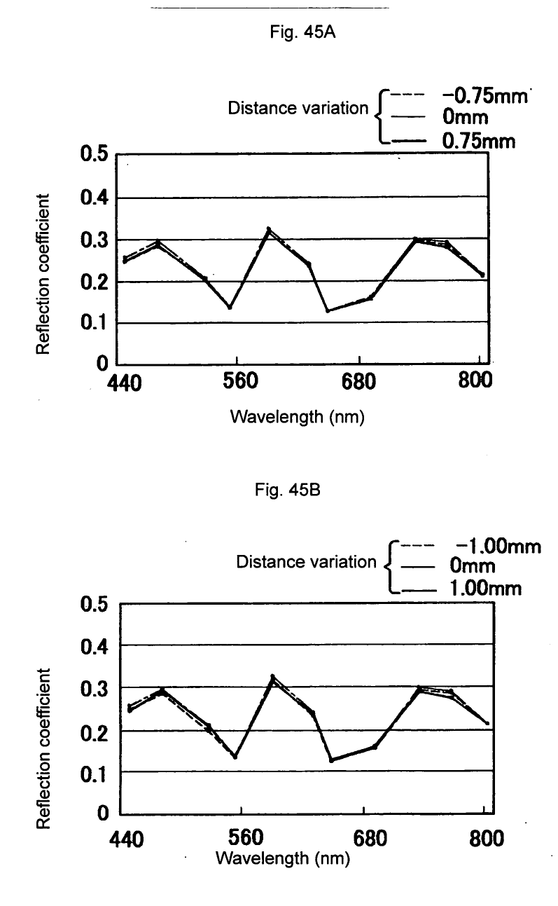

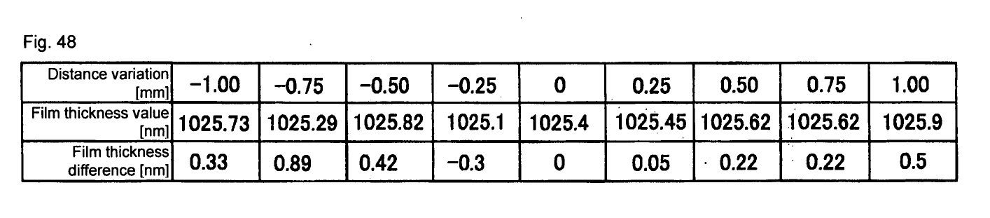

Then, the sample was shifted in distance from the imaging position and then its spectral reflection coefficient was measured. FIG. 44A, 44B, FIGS. 45A and 45B show the spectral reflection coefficients when the sample is shifted from the imaging position by ±0.25 mm, ±0.50 mm, ±0.75 mm, and ±1.00 mm, respectively and the spectral reflection coefficient when the sample is positioned at the imaging position. FIG. 48 shows film thickness values of the SiO₂ film 84 calculated from the results of FIG. 44A, 44B, FIGS. 45A and 45B and their film thickness differences (measurement errors). As can be seen from FIG. 48, the film thickness difference is largest, that is, 0.89 nm when the distance variation is −0.75 mm. However, even in this case, the measurement error is only 0.087%.

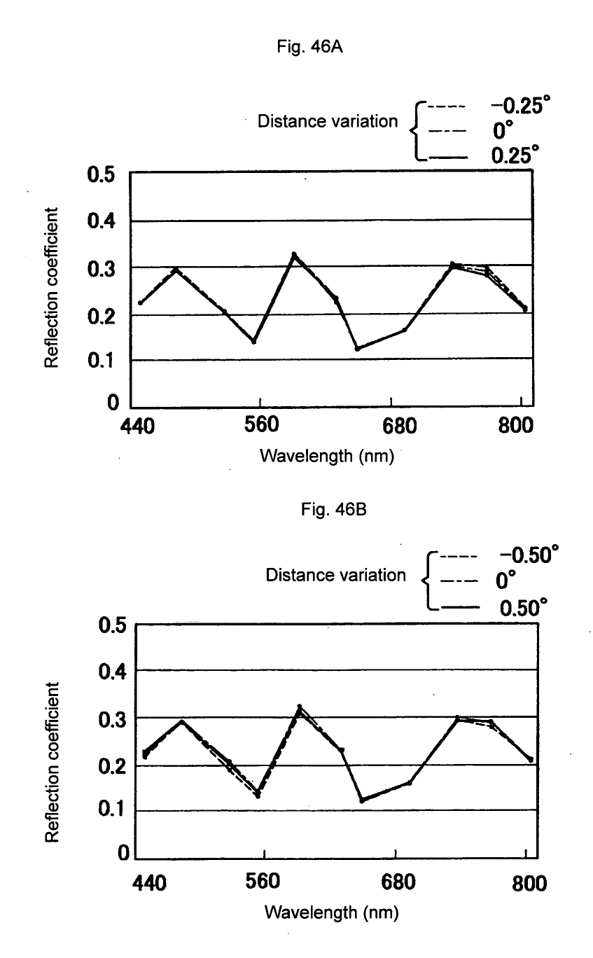

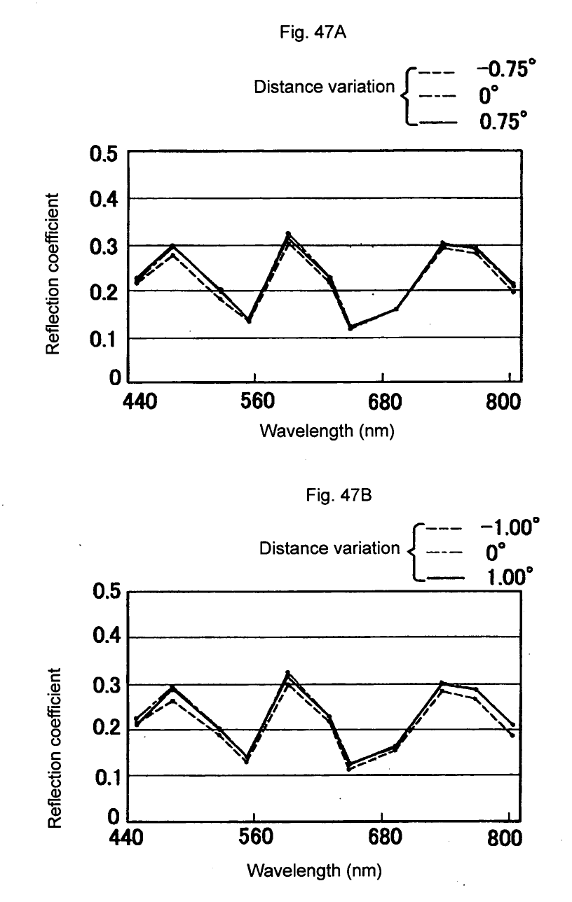

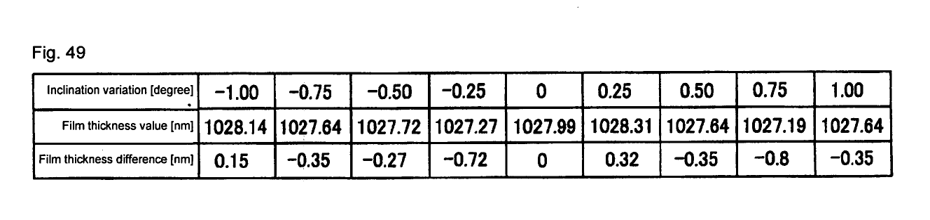

In addition, the sample is inclined and its spectral reflection coefficients were measured. FIG. 46A, 46B, FIGS. 47A and 47B show the spectral reflection coefficients when the sample is inclined by ±0.25°, ±0.50°, ±0.75°, and ±1.00°, respectively and the spectral reflection coefficient when the sample is not inclined. FIG. 49 shows film thickness values of the SiO₂ film 84 calculated from the results of FIG. 46A, 46B, FIGS. 47A and 47B and their film thickness differences (measurement errors) As can be seen from FIG. 49, the film thickness difference is largest, that is, −0.8 nm when the inclination variation is 0.75°. However, even in this case, the measurement error is only 0.078%.

Thus, according to the film thickness measuring system of this embodiment 3, it is shown that when the measurement object shown in FIG. 38 is measured, even if the distance variation or inclination variation of the measurement object is generated, since it hardly affect the spectral reflection coefficient and the measured value of the film thickness, there is provided the optical system which is immune to the distance variation or the inclination variation.

### Embodiment 4

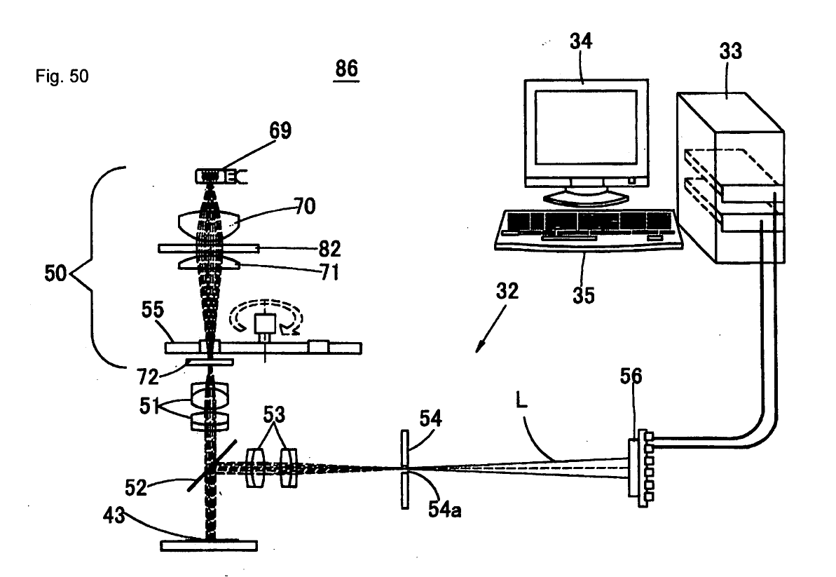

FIG. 50 is a schematic view showing an optical system of a film thickness measuring system 86 according to an embodiment 4 of the present invention. The film thickness measuring system 86 of the embodiment 4 can measure a two-dimensional film thickness with precision higher than that of the film thickness measuring system 81 of the embodiment 3.

According to this film thickness measuring system 86, a projection lens 51, a multi-spectral filter 55 and a light source 50 are provided above a half mirror 52, and an objective lens 53, an aperture stop 54 and a image-taking unit 56 are arranged by the side of the half mirror 52. Thus, measuring light L projected perpendicularly from the light source 50 passes through any one of spectral filters 57a, 57b . . . of the multi-spectral filter 55, becomes a monochromatic light, and passes through the projection lens 51 and the half mirror 52, and then a measurement object 43 is coaxially illuminated with the light. The measuring light L reflected by the measurement object 43 is reflected by the half mirror 52 in the horizontal direction and then provides an image at the image-taking unit 56 through a telecentric optical system on the object side, which is constituted by the objective lens 53 and a small aperture 54a.

According to the film thickness measuring system 81 described in the embodiment 3, the light reflected by the measurement object 43 passes through the half mirror 52, the objective lens 53, the small aperture 54a and multi-spectral filter 55 and it is observed at the image-taking unit 56. Therefore, according to the film thickness measuring system 81, when the half mirror 52 is thick, since focused positions are different between in the vertical direction and in the lateral direction, its optical resolution could be lowered.

Meanwhile, according to the film thickness measuring system 86 of the embodiment 4, since the light reflected by the measurement object 43 is focused at the same position in the vertical direction and the lateral direction, its optical resolution can be improved.

In addition, according to the embodiment 3, since the multi-spectral filter 55 is arranged on the light-receiving side, a ghost is generated by an influence of multiple reflection of front and back surfaces of the spectral filters 57a, 57b, . . . and thus it is necessary to incline the spectral filters 57a, 57b, . . . and the like. Meanwhile, according to the film thickness measuring system 86 of the embodiment 4, since the multi-spectral filter 55 is arranged on the light-projecting side, the ghost is not generated. As a result, according to the film thickness measuring system 86 of the embodiment 4, the two-dimensional film thickness can be measured with higher precision.

According to the film thickness measuring system of the present invention, since inline measurement of the film thickness of the thin film can be implemented in the two-dimensional region of the measurement object, it can be used in testing the film thickness of the thin film formed on a semiconductor substrate or a glass substrate, for example.

1. A two-dimensional spectroscopic system comprising:
a light-projecting optical system in which a measurement object is irradiated with light from a light source;
an image-taking device for taking a monochromatic image of the measurement object; and
a light-receiving optical system in which an image of the measurement object is provided at the image-taking device, wherein the light-receiving optical system is constituted by a telecentric light-receiving optical system comprising an image-forming device and an aperture stop.

2. The two-dimensional spectroscopic system according to claim 1, wherein the image-forming device exists on the measurement object side of the aperture stop.

3. The two-dimensional spectroscopic system according to claim 1, wherein an optical axis of the light-projecting optical system and an optical axis of the light-receiving optical system are coaxially provided only on the side of the measurement object of the aperture stop in the light-receiving optical system.

4. The two-dimensional spectroscopic system according to claim 1, wherein spot light generated at a position of the aperture stop by the light output from the light source and reflected by the measurement object is larger than a size of a small aperture of the aperture stop.

5. The two-dimensional spectroscopic system according to claim 4, wherein the measurement object reflects incident light by specular reflection, and
a numerical aperture on an image side in the light-projecting optical system is greater than a numerical aperture on an object side in the light-receiving optical system.

6. The two-dimensional spectroscopic system according to claim 5, wherein the light source outputs light which provides an image on the measurement object through the light-projecting optical system and provides a uniform distribution of an outgoing light amount on a plane which is in an image-forming relation with a surface of the measurement object.

7. The two-dimensional spectroscopic system according to claim 5, wherein the light source outputs light which provides an image on the aperture stop through the light-projecting optical system, the measurement object and the light-receiving optical system, and provides a uniform distribution of an outgoing light amount on a plane which is in an image-forming relation with the aperture stop.

8. The two-dimensional spectroscopic system according to claim 1, wherein the optical axis of the light-projecting optical system and the optical axis of the light-receiving optical system are coaxially provided only between the image-forming device and the measurement object.

9. The two-dimensional spectroscopic system according to claim 1, wherein an aperture diameter of the aperture stop is set so that the numerical aperture on the object side in the light-receiving optical system becomes 0.02 or less.

10. The two-dimensional spectroscopic system according to claim 1, wherein a splitting device for splitting the light reflected by the measurement object is provided in the light-receiving optical system.

11. The two-dimensional spectroscopic system according to claim 1, wherein a splitting device for projecting a split light onto the measurement object is provided in the light-projecting optical system.

12. The two-dimensional spectroscopic system according to claim 11, wherein the light-projecting optical system is arranged such that an optical axis direction of the light-projecting optical system is almost parallel to a normal line direction of the measurement object.

13. A film thickness measuring system comprising the two-dimensional spectroscopic system according to claim 1 and an arithmetic processing device for calculating a film thickness of a measurement object based on an monochromatic image provided by the two-dimensional spectroscopic system.
